(19) United States
(12) Patent Application Publication
(10) Pub. No.: US 2026/0017012 A1
(43) Pub. Date: Jan. 15, 2026

(54) INFORMATION PROCESSING METHOD, INFORMATION PROCESSING DEVICE, AND NON-TRANSITORY COMPUTER READABLE STORAGE MEDIUM

(71) Applicant: PANASONIC INTELLECTUAL PROPERTY MANAGEMENT CO., LTD., Osaka (JP)

(72) Inventors: Takeshi SAKAI, Hyogo (JP); Tetsuji SADOSHIMA, Nara (JP)

(73) Assignee: PANASONIC INTELLECTUAL PROPERTY MANAGEMENT CO., LTD., Osaka (JP)

(21) Appl. No.: 19/338,834

(22) Filed: Sep. 24, 2025

Related U.S. Application Data
(63) Continuation of application No. PCT/JP2024/004027, filed on Feb. 7, 2024.
(60) Provisional application No. 63/455,345, filed on Mar. 29, 2023.

(30) Foreign Application Priority Data
Nov. 15, 2023 (JP) 2023-194521

(51) Int. Cl. G06F 3/16; G06F 3/01

(52) U.S. Cl. CPC G06F 3/165; G06F 3/011; G06F 2203/011

(57) ABSTRACT

An information processing device acquires a value of a factor with respect to each of a plurality of sound contents; acquires a user state that is a state of a user related to the factor; selects a sound content having a value of the factor according to the user state from the plurality of sound contents; and reproduces the selected sound content in a space where the user is present.

### FIELD OF INVENTION

The present disclosure relates to a technique for forming a space according to a state of a user.

### BACKGROUND ART

Non-Patent Literature 1 discloses that a frequency of decreasing an arousal level of a user is reduced by providing the user with an airflow according to the arousal level of the user.

However, Non-Patent Literature 1 merely discloses that the airflow provided to the user is controlled according to the arousal level of the user, and in this case, it is not possible to form an environment (hereinafter, a sound environment) surrounded by sound according to a state of the user in a space where the user is present.

Non-Patent Literature 1: Atsushi Nishino and four others, “Research on Small Space Environment that Enhances Comfort and Intellectual Productivity When Working From Home Part 2: Verification of Arousal Effect by Airflow Stimulation in Small Space”, Summaries of technical papers of annual meeting, Architectural Institute of Japan (Kinki), September 2023

### SUMMARY OF THE INVENTION

An object of the present disclosure is to provide a technique for forming a sound environment according to a state of a user in a space where the user is present.

An information processing method according to one aspect of the present disclosure is an information processing method in a computer, the method including: acquiring a value of a factor with respect to each of a plurality of sound contents; acquiring a user state that is a state of a user related to the factor; selecting a sound content having the value of the factor according to the user state from the plurality of sound contents; and reproducing the selected sound content in a space where the user is present.

### BRIEF DESCRIPTION OF THE DRAWINGS

FIG. 1 is a view illustrating one example of an experimental environment.

FIG. 2 is a diagram illustrating one example of a plurality of sound environmental conditions.

FIG. 3 is a diagram illustrating features of a plurality of sound contents.

FIG. 4 is a diagram illustrating frequency characteristics of each of the types of sound contents illustrated in FIG. 3.

FIG. 5 is a diagram illustrating a time-series change in amplitude when each of the types of sound contents illustrated in FIG. 3 was stereoscopically reproduced.

FIG. 6 is a diagram illustrating evaluation items and evaluation words with respect to each of the sound environments.

FIG. 7 is a diagram illustrating an evaluation scale with respect to each of the evaluation items.

FIG. 8 is a diagram illustrating a relationship among the evaluation items, factor loading, and factors.

FIG. 9 is a diagram illustrating one example of results of factor analysis and cluster analysis of evaluation results.

FIG. 10 is a diagram illustrating one example of results of factor analysis and cluster analysis of evaluation results.

FIG. 11 is a block diagram illustrating a configuration of an information processing system according to an embodiment of the present disclosure.

FIG. 12 is a flowchart illustrating processing executed by an information processing device.

FIG. 13 is a diagram illustrating one example of a first selection table.

FIG. 14 is a diagram illustrating a relationship between a value of a first factor and a value of a second factor with respect to the plurality of sound contents.

FIG. 15 is a diagram illustrating one example of a second selection table.

FIG. 16 is a diagram illustrating a relationship between a value of the first factor and a value of the second factor with respect to the plurality of sound contents.

FIG. 17 is a diagram illustrating one example of a time-series change in a relaxation degree of a user.

FIG. 18 is a diagram illustrating one example of a time-series change in a concentration degree of the user.

FIG. 19 is a view illustrating one example of another experimental environment.

FIG. 20 is a diagram illustrating one example of results of factor analysis and cluster analysis of other evaluation results.

FIG. 21 is a diagram illustrating one example of results of factor analysis and cluster analysis of other evaluation results.

FIG. 22 is a diagram illustrating one example of a third selection table.

FIG. 23 is a diagram illustrating a relationship between a value of the first factor and a value of the second factor with respect to the plurality sound contents.

FIG. 24 is a diagram illustrating one example of a fourth selection table.

FIG. 25 is a diagram illustrating a relationship between a value of the first factor and a value of the second factor with respect to the plurality of sound contents.

FIG. 26 is a diagram illustrating one example of screens related to the processing illustrated in FIG. 12.

### DETAILED DESCRIPTION

### (Process Leading to One Aspect of Present Disclosure)

In recent years, stress relaxation of office workers has been regarded as important due to work style change and the COVID-19 pandemic, and an office environment has been reviewed. Health management has been promoted in companies, and biophilic design (hereinafter, BD) has attracted attention. In the study on BD, a green coverage rate and influence of viewing green have been studied. In a sound environment field, it has been reported that, for example, adding music or natural sound in a quiet office makes it easier to work, and comfort is improved by a sense of harmony between vision and hearing. However, a sound environment in the BD has not been sufficiently studied. A possibility can be considered that intellectual productivity is further improved by the study. Therefore, the present inventors conducted subjective evaluation experiments on office workers for the purpose of clarifying an optimum type and presentation level of natural sound in view of application to the BD.

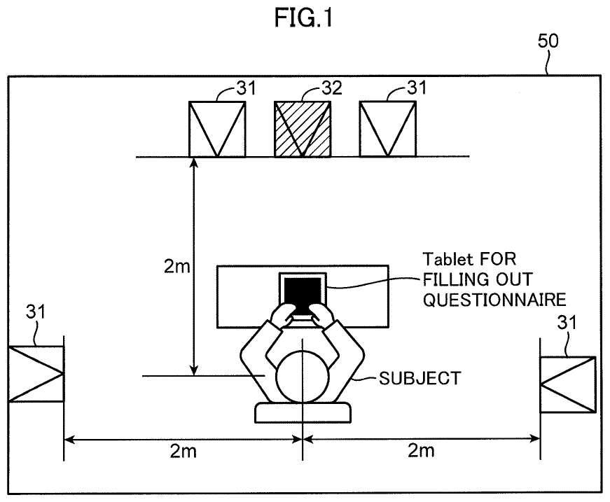

FIG. 1 is a view illustrating one example of an experimental environment. Specifically, the present experiment was performed in an anechoic chamber 50 for two days. Subjects were 16 office workers (eight males and eight females) in their twenties to fifties. In a center of the anechoic chamber 50, a desk for allowing each of the subjects to perform work of filling out a questionnaire using a tablet terminal was disposed. Speakers 31 that reproduce a sound content indicating base sound as background noise were disposed at positions 2m away from the subject in a left direction and a right direction. Two speakers 31 and one speaker 32 that reproduces a sound content indicating natural sound to be added to the base sound were disposed at positions 2m away from the subject in a front direction.

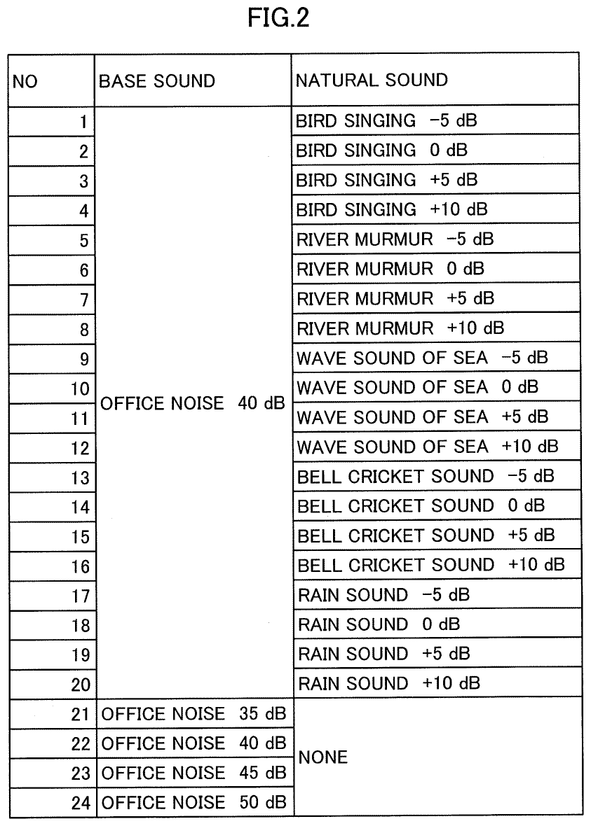

FIG. 2 is a diagram illustrating one example of a plurality of sound environmental conditions. In order that the sound environment inside the anechoic chamber 50 satisfies each of 24 sound environmental conditions illustrated in FIG. 2, the sound content indicating the base sound is reproduced by the four speakers 31, and the sound content indicating the natural sound is reproduced by the speaker 32. Note that the plurality of sound environmental conditions were randomly applied in consideration of an order effect.

For example, the sound environmental condition “base sound: office noise 40 dB, natural sound: bird singing sound −5 dB” of NO “1” in FIG. 2 indicates that the base sound is office noise of 40 dB, and the natural sound is bird singing sound in which a volume of a difference with respect to the base sound (an S/N ratio with respect to a sound pressure level of the base sound) is-5 dB. Hereinafter, the volume of the difference between the natural sound and the base sound will be simply abbreviated as a volume. The sound environment satisfying the sound environmental condition was realized by causing the speakers 31 to reproduce a sound content indicating the office noise of 40 dB and causing the speaker 32 to reproduce a sound content indicating bird singing sound of 35 dB (=40 dB−5 dB).

In addition, a sound environmental condition “base sound: office noise 35 dB” of NO “21” in FIG. 2 indicates that the base sound is office noise of 35 dB and there is no natural sound. The sound environment satisfying the sound environmental condition was realized by causing the speakers 31 to reproduce a sound content indicating office noise of 35 dB.

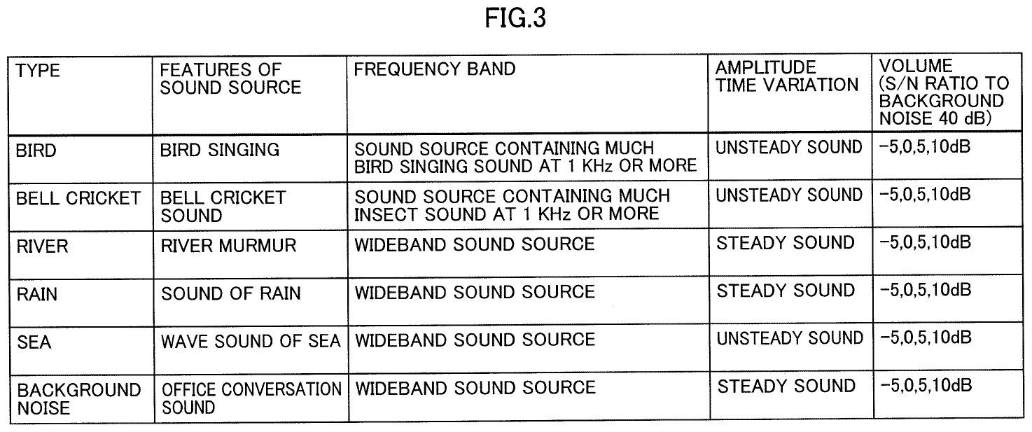

FIG. 3 is a diagram illustrating features of a plurality of sound contents. In order to realize sound environments satisfying the 24 sound environmental conditions of NO “1” to “24” illustrated in FIG. 2, 24 sound contents of six types of “bird”, “bell cricket”, “river”, “rain”, “sea”, “background noise”, and four volumes “−5 dB”, “0 dB”, “+5 dB”, and “+10 dB” illustrated in FIG. 3 were used. The volumes illustrated in FIG. 3 each indicate the volume (the S/N ratio) of the difference with respect to the background noise of 40 dB.

For example, in the case where the sound environment satisfying the sound environmental condition “base sound: office noise 40 dB, natural sound: bird singing sound-5 dB” of NO “1” in FIG. 2 was realized, a sound content of the type “background noise” in which a feature of a sound source is “office conversation sound”, and the volume “0 dB” (actually, 40 (=40−0) dB) illustrated in FIG. 3 was reproduced by the speakers 31 as the base sound. In this case, a sound content of the type “bird” in which the feature of the sound source is “bird singing” and the volume “−5 dB” (actually, 35 (=40−5) dB) was further reproduced as the natural sound by the speaker 32.

In addition, in the case where the sound environment satisfying the sound environmental condition “base sound: office noise 35 dB” of NO “21” in FIG. 2 was realized, a sound content of the type “background noise” in which the feature of the sound source is “office conversation sound” illustrated in FIG. 3, and the volume “−5 dB” (actually, 35 (=40−5) dB) was reproduced by the speakers 31 as the base sound.

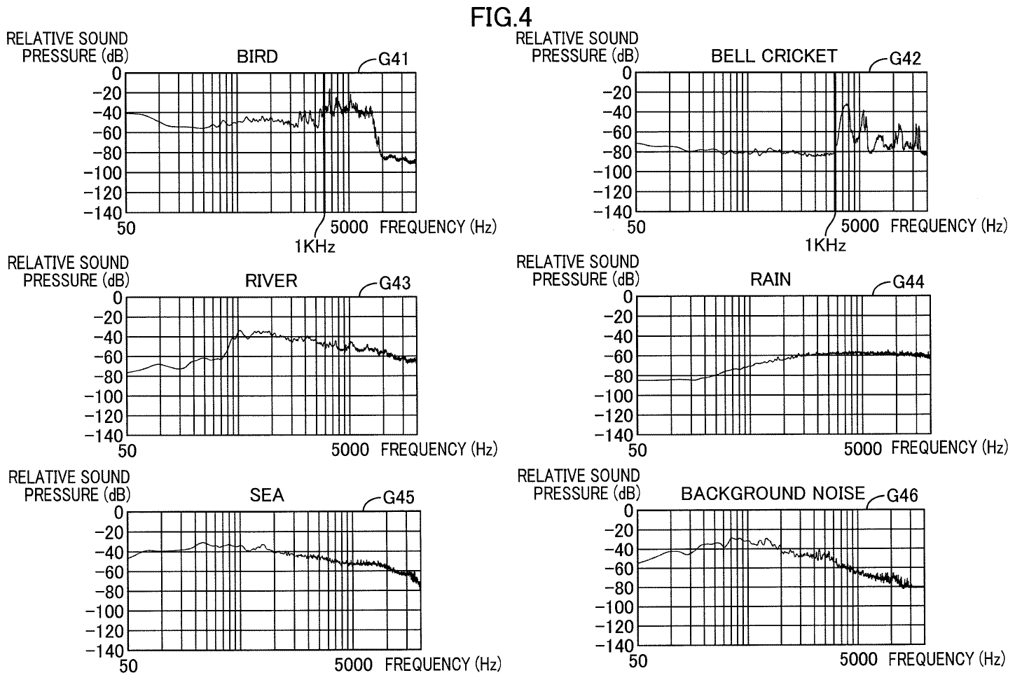

FIG. 4 is a diagram illustrating frequency characteristics of each of the types of sound contents illustrated in FIG. 3. FIG. 4 illustrates graphs G41 to G45 illustrating frequency characteristics of the five types of sound contents “bird”, “bell cricket”, “river”, “rain”, and “sea” indicating the natural sound illustrated in FIG. 3, and a graph G46 illustrating frequency characteristics of one type of sound content “background noise” indicating the base sound illustrated in FIG. 3. In the graphs G41 to G46, a horizontal axis represents a frequency (Hz), and a vertical axis represents a relative sound pressure (dB).

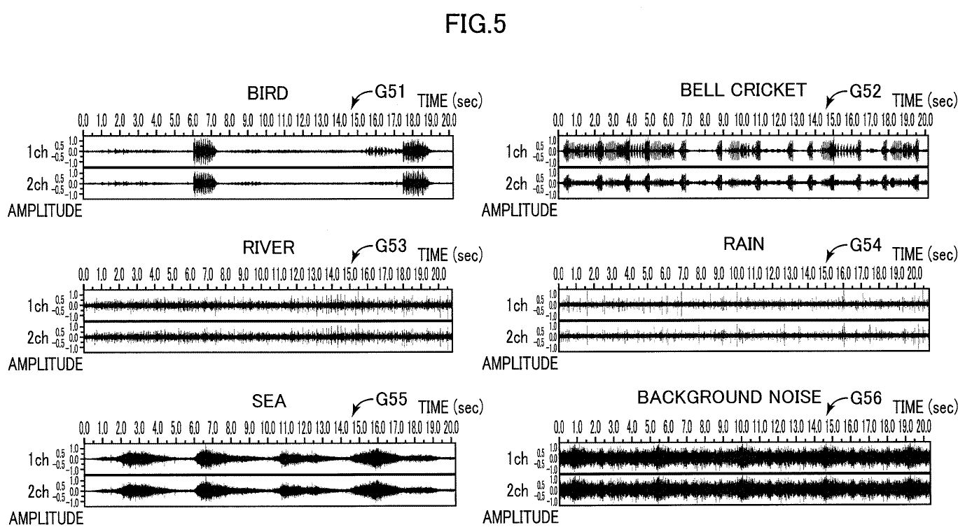

FIG. 5 is a diagram illustrating a time-series change in amplitude when each of the types of sound contents illustrated in FIG. 3 was stereoscopically reproduced. FIG. 5 illustrates graphs G51 to G55 each illustrating the time-series change in amplitude when each of the five types of the sound contents “bird”, “bell cricket”, “river”, “rain”, and “sea” indicating the natural sound was stereoscopically reproduced, and a graph G56 illustrating a time-series change in amplitude when the one type of the sound content “background noise” indicating the base sound was stereoscopically reproduced. A horizontal axis of each of the graphs G51 to G56 represents time, and a vertical axis represents an amplitude.

For example, the sound content of the type “bird” is, as illustrated in the graph G41 in FIG. 4 and the graph G51 in FIG. 5, a sound content having, as a sound source, unsteady sound including bird singing sound in a frequency band of 1 KHz or more. In the present experiment, the sound contents of the type “bird” of the four volumes “−5 dB”, “0 dB”, “+5 dB”, and “+10 dB” were used.

As illustrated in the graph G43 of FIG. 4 and the graph G53 of FIG. 5, the sound content of the type “river” is a sound content having steady sound including river murmur sound in a wide band as a sound source. In the present experiment, the sound contents of the type “river” of the four types of volumes “−5 dB”, “0 dB”, “+5 dB”, and “+10 dB” were used.

As illustrated in the graph G46 of FIG. 4 and the graph G56 of FIG. 5, the sound content of the type “background noise” is a sound content having steady sound including conversation sound in offices in a wide band as a sound source. In the present experiment, the sound contents of the type “background noise” of the four volumes “−5 dB”, “0 dB”, “+5 dB”, and “+10 dB” were used.

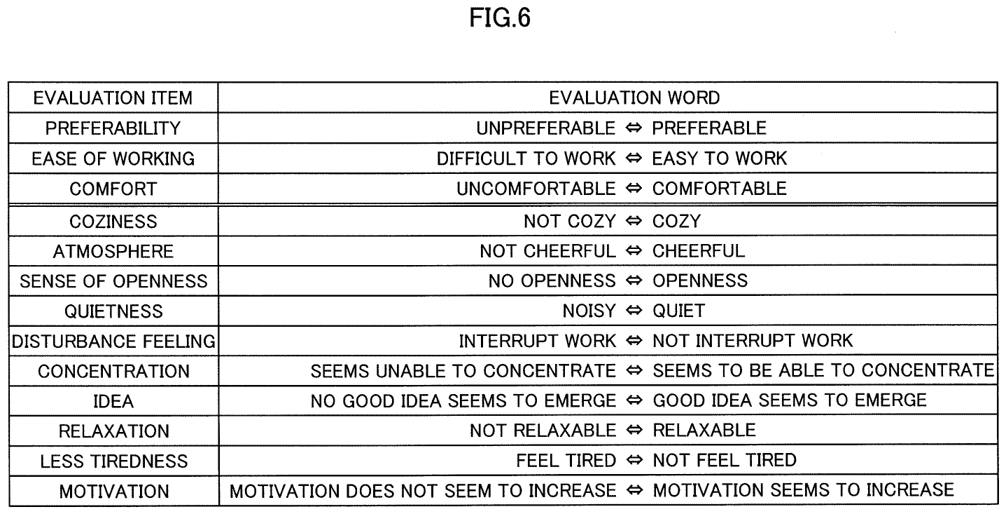

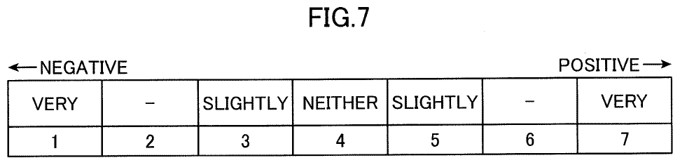

In the present experiment, a questionnaire was conducted in which the subject was asked to answer their impressions of the sound environment satisfying each of the 24 sound environmental conditions illustrated in FIG. 2. FIG. 6 is a diagram illustrating evaluation items and evaluation words with respect to each of the sound environments. The evaluation words illustrated in FIG. 6 are used as a standard in psychological evaluation in offices in the architectural society. FIG. 7 is a diagram illustrating an evaluation scale with respect to each of the evaluation items. In the questionnaire described above, 13 evaluation items illustrated in FIG. 6 were evaluated on the 24 sound environments satisfying the 24 sound environmental conditions by the 7-grade evaluation scale illustrated in FIG. 7.

In addition, in the present experiment, the subject was instructed to assume a situation where he/she was performing personal work such as accounting in a free address space of an office. In addition, in order to grasp an impression of the five types of natural sound, the subject was asked to answer an impression of each of the sound environments 20 seconds after start of reproduction of the sound content. Note that the reproduction of the sound content was continued while the impression of each of the sound environments was answered.

When all the subjects finished their answers, factor analysis and cluster analysis were performed, by using a statistical analysis tool, on evaluation results of all the subjects for 10 evaluation items excluding comprehensive evaluation items “preferability”, “ease of working”, and “comfort” with respect to each of the 24 sound environments.

Note that in the factor analysis, the evaluation scale illustrated in FIG. 7 was used as a reference. Specifically, the evaluation scale “neither” illustrated in FIG. 7 was set to “0”, a positive evaluation scale “slightly” was set to “+1”, a positive evaluation scale “−” was set to “+2”, a positive evaluation scale “very” was set to “+3”, a negative evaluation scale “slightly” was set to “−1”, a negative evaluation scale “−” was set to “−2”, and a negative evaluation scale “very” was set to “−3”. A factor loading was calculated by a maximum likelihood method and Promax rotation. A goodness-of-fit test was performed using chi-square values. As a result, it fell below a significance level of 5%. Factor scores were calculated by the Bartlett method.

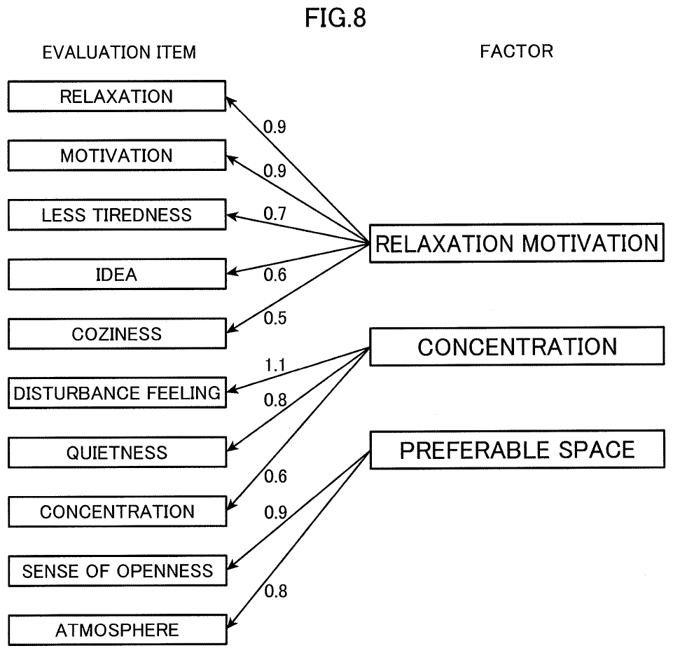

FIG. 8 is a diagram showing a relationship among the evaluation items, the factor loading, and factors. As a result of the factor analysis described above, a factor having high factor loading with respect to the five evaluation items “relaxation”, “motivation”, “less tiredness”, “idea”, and “coziness” related to a relaxation degree of a worker was named as “relaxation motivation”. The relaxation degree of the subject is a degree of relaxation of the subject. A factor having high factor loading for the three evaluation items “disturbance feeling”, “quietness”, and “concentration” related to a concentration degree of the subject was named “concentration”. The concentration degree of the subject is a degree of concentration of the subject. A factor having high factor loading with respect to the two evaluation items “sense of openness” and “atmosphere” related to preferability of the space 5 where the subject was present was named “preferable space”.

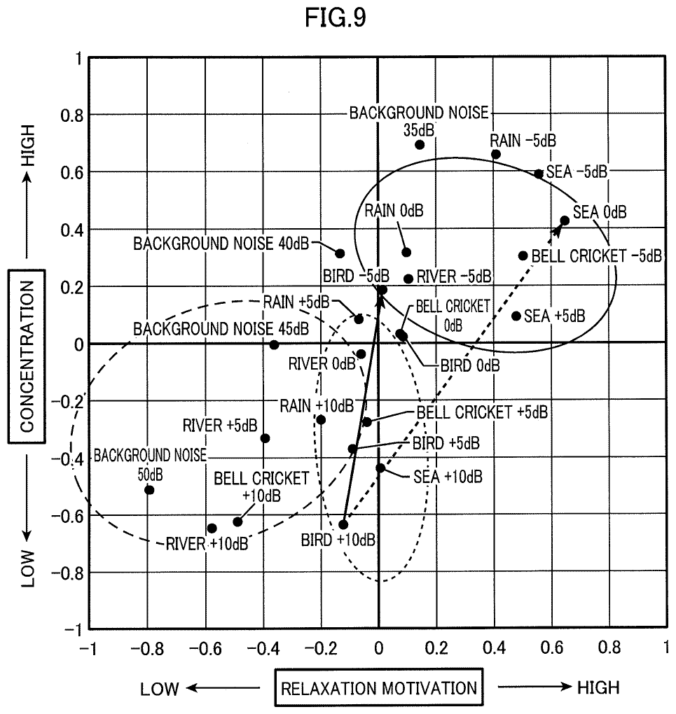

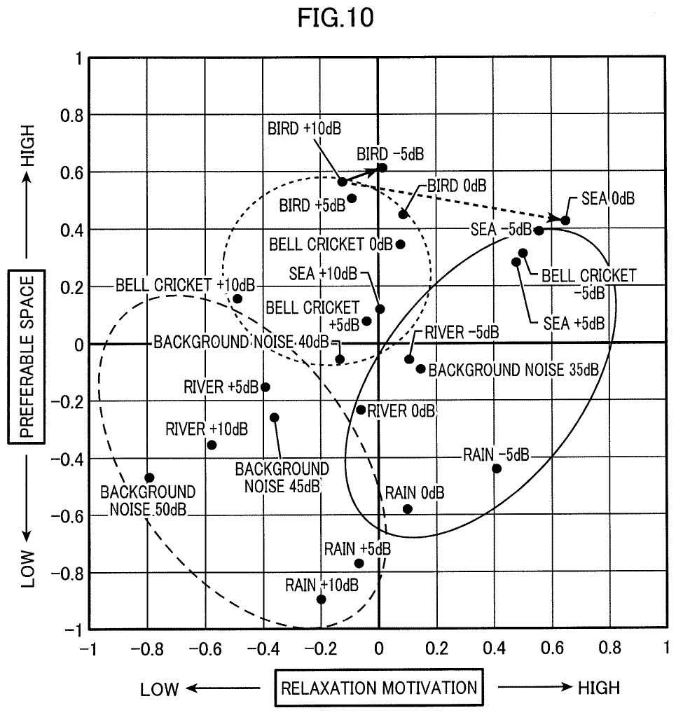

FIGS. 9 and 10 are diagrams illustrating examples of results of the factor analysis and the cluster analysis of the evaluation results. FIG. 9 illustrates a result of arranging the evaluation results with respect to the sound environments with a factor score of the factor “relaxation motivation” on a horizontal axis and a factor score of the factor “concentration” on a vertical axis, and further classifying the evaluation results into three groups by the cluster analysis.

Specifically, in FIG. 9, a circle (a dot) is described in coordinates corresponding to the factor score of the factor “relaxation motivation” and the factor score of the factor “concentration” in the evaluation result with respect to each or the sound environments. In addition, in FIG. 9, the type and the volume (for example, “rain-5 dB”) of the sound content indicating the natural sound reproduced to form each of the sound environments are described in association with the circle (the dot).

In FIG. 9, for the evaluation result of the sound environment formed by reproducing only the sound content indicating the base sound, the type and an actual volume (for example, “background noise 35 dB (=40 dB−5 dB)”) of the sound content indicating the base sound is described instead of the type and the volume (for example, “background noise-5 dB”) of the sound content indicating the base sound reproduced to form the sound environment. Further, in FIG. 9, the three groups classified by the cluster analysis are indicated by ellipses of solid lines, broken lines, and dotted lines.

The factor score of the factor “relaxation motivation” in the evaluation result with respect to each of the sound environments can be said to be a degree of influence that the sound content reproduced to form each of the sound environments has on the relaxation degree of the user, which is a state related to the factor “relaxation motivation” of the user. The factor score of the factor “concentration” in the evaluation result with respect to each of the sound environments can be said to be a degree of influence that the sound content reproduced to form each or the sound environments has on the concentration degree of the user, which is a state related to the factor “concentration” of the user.

Similarly to FIG. 9, FIG. 10 illustrates a result of arranging the evaluation results with respect to the sound environments with the factor score of the factor “relaxation motivation” on a horizontal axis and a factor score of the factor “preferable space” (another factor) on a vertical axis, and further classifying the evaluation results into three groups by the cluster analysis.

The present inventors have obtained findings below 1), 2) by considering FIGS. 9 and 10.

1) As indicated by solid arrows in FIGS. 9 and 10, it is assumed that the sound content to be reproduced as the natural sound is changed to the sound contents of the type “bird” and the volume “−5 dB” under the sound environment where the sound content of the type “bird” and the volume “+10 dB” is reproduced as the natural sound. In this case, it is possible to form a sound environment in which the factor score of the factor “concentration” is improved while maintaining the factor scores of the factor “preferable space” and the factor “relaxation motivation”.

2) As indicated by the broken arrows in FIGS. 9 and 10, it is assumed that the sound content to be reproduced as the natural sound is changed to the sound content of the type “sea” and the volume “0 dB” under the sound environment where the sound content of the type “bird” and the volume “+10 dB” is reproduced as the natural sound. In this case, it is possible to form a sound environment in which the factor score of the factor “relaxation motivation” and the factor “concentration” are improved while maintaining the factor score of the factor “preferable space”.

Therefore, on the basis of the above knowledge, the present inventors have conducted intensive studies on a technique for forming a sound environment according to a state of the user related to each of the factors in a space where the user is present, using the factor score of each of the factors in the evaluation result with respect to the sound environment formed when each of the plurality of sound contents are reproduced. As a result, aspects below of the present disclosure have been conceived. Hereinafter, the factor score of the factor of the evaluation result with respect to the sound environment formed when the sound content is reproduced is abbreviated as a value of the factor with respect to the sound content.

(1) An information processing method according to one aspect of the present disclosure is an information processing method in a computer, the method including: acquiring a value of a factor with respect to each of a plurality of sound contents; acquiring a user state that is a state of a user related to the factor; selecting a sound content having the value of the factor according to the user state from the plurality of sound contents; and reproducing the selected sound content in a space where the user is present.

According to the present configuration, the sound content having the value of the factor according to the user state is reproduced in the space where the user is present. Therefore, the present configuration can form a sound environment according to a state of the user related to the factor in the space where the user is present.

(2) In the information processing method according to the above (1), the plurality of sound contents may include a predetermined sound content, and in the selection, in a case where the user state has not reached a target state, any one sound content having a higher value of the factor than that of the predetermined sound content may be selected.

In the present configuration, in the case where the user state has not reached the target state, one sound content having a higher value of the factor than that of the predetermined sound content is reproduced. Therefore, in the present configuration, the state of the user related to the factor can be improved as compared with a case of reproducing the predetermined sound content, and can be brought close to the target state.

(3) The information processing method according to the above (2), wherein in the selection, in a case where the user state exceeds the target state, any one sound content having a lower value of the factor than that of the predetermined sound content may be further selected.

In the present configuration, in the case where the user state exceeds the target state, one sound content having a lower value of the factor than that of the predetermined sound content is further reproduced. Therefore, in the present configuration, the state of the user related to the factor can be suppressed as compared with the case of reproducing the predetermined sound content, and can be brought close to the target state.

(4) In the information processing method according to the above (2) or (3), background noise of the space may be further acquired, and in the selection, the background noise in the space may be set as the predetermined sound content.

According to the present configuration, when the user state has not reached the target state, one sound content is reproduced which has a higher value of the factor than that of the background noise of the space where the user is present. Therefore, in the present configuration, the state related to the factor of the user can be improved as compared with the case of not reproducing the sound content, and can be brought close to the target state.

(5) In the information processing method according to the above (2) or (3), the acquisition, the selection, and the reproduction of the user state may be repeated every time predetermined time elapses, and in the selection, a sound content being reproduced in the space may be set as the predetermined sound content.

In the present configuration, in the case where the user state is not the target state, one sound content having a higher or lower value of the factor than that of the sound content being reproduced in the space where the user is present is selected and reproduced each time the predetermined time elapses. Therefore, in the present configuration, the state of the user related to the factor can be gradually improved or suppressed, and can be brought close to the target state.

(6) In the information processing method according to any one of the above (1) to (5), the plurality of sound contents may include a plurality of types of sound contents, and each of the types of the sound contents may include sound contents of one or more volumes.

According to the present configuration, it is possible to select and reproduce, in the space where the user is present, the sound content according to the user state from the sound contents of the plurality of types and the one or more volumes. Therefore, the present configuration can flexibly form a sound environment suitable for the state of the user related to the factor.

(7) In the information processing method according to the above (6), each of the one or more volumes may be represented by a volume of a difference with respect to a volume of background noise in the space.

According to the present configuration, in the space where the user is present, it is possible to reproduce the sound content in which the volume of the difference with respect to the volume of background noise in the space is suitable for the state of the user related to the factor.

(8) In the information processing method according to the above (2) or (3), in the acquisition of the user state, a relaxation degree indicating a degree of relaxation of the user may be acquired as the user state, the target state may be a state in which the relaxation degree is a predetermined value, and the value of the factor may be a value indicating a degree of influence of each of the sound contents on the relaxation degree.

In the present configuration, in the case where the relaxation degree has not reached the predetermined value, one sound content having a higher degree of the influence on the relaxation degree than that of the predetermined sound content is reproduced. Therefore, in the present configuration, the degree of the relaxation of the user can be improved as compared with the case where the predetermined sound content is reproduced, and the state can be brought closer to the target state.

(9) In the information processing method according to the above (2) or (3), in the acquisition of the user state, a concentration degree indicating a degree of concentration of the user may be acquired as the user state, the target state may be a state in which the concentration degree is a predetermined value, and the value of the factor may be a value indicating a degree of influence of each of the sound contents on the concentration degree.

In the present configuration, in a case where the concentration degree has not reached the predetermined value, one sound content having a higher degree of the influence on the concentration degree than that of the predetermined sound content is reproduced. Therefore, in the present configuration, the degree of concentration of the user can be improved as compared with the case where the predetermined sound content is reproduced, and the state can be brought closer to the target state.

(10) In the information processing method according to the above (5), in the selection, a list may be acquired in which sound contents each having the value of the factor equal to or more than a reference value among the plurality of sound contents are arranged in order of a magnitude of the value of the factor, and a sound content having arrangement order in the list before or next to the predetermined sound content may be selected.

According to the present configuration, the sound content to be reproduced in the space where the user is present can be efficiently selected by limiting to sound contents each having the value of the factor equal to or more than the reference value and following the arrangement order in the list.

(11) In the information processing method according to the above (10), a value of another factor with respect to the plurality of sound contents may be further acquired, and in the selection, the list may be acquired in which the value of the factor of a sound content having a highest value of the other factor among the plurality of sound contents is set as the reference value.

According to the present configuration, the sound content to be reproduced in the space where the user is present can be efficiently selected by limiting to sound contents each having the value of the factor equal to or more than the value of the factor of the sound content having the highest value of the other factor, and following arrangement order in the list.

(12) In the information processing method according to the above (11), the value of the other factor may be a value indicating a degree of influence of each of the sound contents on preferability of the space.

According to the present configuration, the sound content to be reproduced in the space where the user is present can be efficiently selected by limiting to sound contents each having the value of the factor equal to or more than the value of the factor of the sound content having the highest degree of influence on the preferability of the space, and following arrangement order in the list.

(13) In the information processing method according to any one of the above (1) to (12), an adjustment value of the factor may be further acquired, the adjustment value being a value of the factor with respect to each of the plurality of sound contents in a case where a predetermined facility is provided in the space, and in the selection, in the case where the predetermined facility is provided in the space, a sound content having the adjustment value of the factor according to the user state may be selected from the plurality of sound contents.

In the present configuration, in the case where the predetermined facility is provided in the space where the user is present, the sound content of the adjustment value of the factor according to the user state is reproduced in the space. Therefore, the present configuration can form a sound environment according to the state of the user related to the factor in the space where the predetermined facility is provided.

(14) In the information processing method according to the above (13), the predetermined facility may be planting.

In the present configuration, in the case where the planting is provided in the space where the user is present, the sound content of the adjustment value of the factor according to the user state is reproduced in the space. Therefore, the present configuration can form a sound environment according to the state of the user related to the factor in the space where the planting is provided.

(15) In the information processing method according to the above (5), in the selection, the predetermined time may be shortened as a difference between the user state and the target state is larger.

In present configuration, the larger the difference between the user state and the target state is, the shorter the predetermined time is. Therefore, in the present configuration, as the difference between the user state and the target state is larger, a frequency of gradually improving or suppressing the state of the user related to the factor is increased, and the state related to the factor of the user can be quickly brought closer to the target state.

(16) An information processing device of another aspect of the present disclosure includes: a factor acquisition unit that acquires a value of a factor with respect to each of a plurality of sound contents; an acquisition unit that acquires a user state that is a state of a user related to the factor; a selection unit that selects a sound content having a value of the factor according to the user state from the plurality of sound contents; and a reproduction unit that reproduces the selected sound content in a space where the user is present.

According to the present configuration, operation and effects similar to those of the information processing method described in the above (1) can be obtained.

(17) A non-transitory computer readable storage medium according to another aspect of the present disclosure is a non-transitory computer readable storage medium storing a program of an information processing device, the program causing the information processing device to function as: a factor acquisition unit that acquires a value of a factor with respect to a plurality of sound contents; an acquisition unit that acquires a user state that is a state of a user related to the factor; a selection unit that selects a sound content having a value of the factor according to the user state from the plurality of sound contents; and a reproduction unit that reproduces the selected sound content in a space where the user is present.

According to the present configuration, operation and effects similar to those of the information processing method described in the above (1) can be obtained.

(18) In the information processing method according to any one of the above (1) to (15), biological information of the user sensed by a sensor may be further acquired, and in the acquisition of the user state, the user state may be estimated on a basis of the biological information of the user.

In the present configuration, the user state is estimated on the basis of the biological information of the user sensed by the sensor, and the sound content of the value of the factor corresponding to the user state is reproduced in the space where the user is present. Therefore, the present configuration can form a sound environment according to the state of the user related to the factor in the space where the user is present.

Note that all embodiments described below show specific examples of the present disclosure. Numerical values, shapes, constituent elements, steps, order of the steps, and the like of the following embodiments are merely examples, and do not intend to limit the present disclosure. A constituent element not described in an independent claim representing a highest concept among constituent elements in the embodiments below is described as an optional constituent element. In all the embodiments, a content of each of the embodiments can be combined.

### First Embodiment

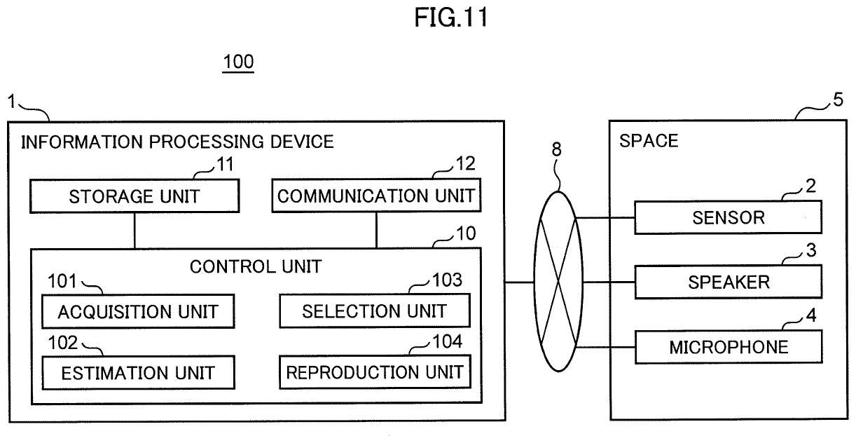

FIG. 11 is a block diagram illustrating a configuration of an information processing system 100 in an embodiment of the present disclosure. As illustrated in FIG. 1, the information processing system 100 includes an information processing device 1, a sensor 2, a speaker 3, and a microphone 4.

The information processing device 1 is communicably connected to the sensor 2, the speaker 3, and the microphone 4 via a network 8. The information processing device 1 includes, for example, a computer such as a cloud server or an edge server. In a case where the information processing device 1 is a cloud server, the network 8 includes, for example, the Internet. In a case where the information processing device 1 is an edge server, the network 8 includes, for example, a local area network.

The sensor 2, the speaker 3, and the microphone 4 are installed in a space 5 where a user of the information processing system 100 is present. Hereinafter, the user of the information processing system 100 will be abbreviated as a user. The space 5 includes, for example, a work room such as a living room and a study room in a residence where the user lives, an office room, and the like. The user performs work inside the space 5 by using a terminal device (not illustrated) such as a personal computer. The work performed by the user includes, for example, intelligent work such as desk work and study, assembly work, drawing work, and the like.

The sensor 2 is a device that acquires (senses) information indicating a living body of the user (hereinafter, biological information). The sensor 2 includes a communication circuit (not illustrated), periodically acquires the biological information of the user, and transmits the acquired biological information of the user to the information processing device 1 using the communication circuit.

The sensor 2 is, for example, a cerebral blood flow sensor, an electrocardiographic sensor, an electroencephalogram sensor, a pulse wave sensor, or the like. The cerebral blood flow sensor includes, for example, a near-infrared sensor (NIRS), and detects a hemoglobin concentration as the biological information. The electrocardiographic sensor includes, for example, an electrode, and detects a heart rate or the like of the user as the biological information. The electroencephalogram sensor includes, for example, an electrode, and detects an electroencephalogram of the user as the biological information. The pulse wave sensor includes, for example, a light emitting element and a light receiving element, and after irradiating a body surface of the user with light, detects, as the biological information, a pulse wave of the user from an amount of change in an amount of light transmitted or reflected. Furthermore, the sensor 2 may be, for example, an image sensor, an audio sensor, or the like. The image sensor includes, for example, a camera, and detects a posture of the user as the biological information from an image captured by the camera. The audio sensor includes, for example, a microphone, and detects voice of the user as the biological information from audio collected by the microphone.

The speaker 3 is a device that reproduces a sound content inside the space 5. The speaker 3 includes a communication circuit (not illustrated), and when the communication circuit receives a control signal from the information processing device 1, the speaker 3 reproduces base sound or natural sound indicated by a sound content instructed by the control signal at a volume indicated by the sound content.

The microphone 4 is a device that collects audio inside the space 5. The microphone 4 includes a communication circuit (not illustrated). When the communication circuit receives a control signal indicating an instruction to transmit audio data to the information processing device 1, the microphone 4 collects the audio inside the space 5, and transmits the audio data indicating the collected audio inside the space 5 to the information processing device 1 using the communication circuit.

The information processing device 1 includes a storage unit 11, a communication unit 12, and a control unit 10.

The storage unit 11 includes a nonvolatile rewritable storage device such as a hard disk drive or a solid state drive. The storage unit 11 stores the 24 sound contents classified into the six types and the four volumes illustrated in FIGS. 3 to 5 used in the above experiment.

The storage unit 11 stores (acquires) the factor score of the factor “relaxation motivation”, the factor score of the factor “concentration”, and the factor score of the factor “preferable space” in the evaluation result with respect to the sound environment formed when each of the 24 sound contents classified into the above six types and four volumes obtained in the above experiments is reproduced. For example, the storage unit 11 stores the factor score of the factor “relaxation motivation”, the factor score of the factor “concentration”, and the factor score of the factor “preferable space” in the evaluation result with respect to the sound environment formed when the sound content of the type “bird” and the volume “0 dB” is reproduced.

Hereinafter, the factor score of the factor “relaxation motivation”, the factor score of the factor “concentration”, and the factor score of the factor “preferable space” of the evaluation result with respect to the sound environment formed when the sound content is reproduced are described as a value of the factor “relaxation motivation”, a value of the factor “concentration”, and a value of the factor “preferable space” with respect to the sound content.

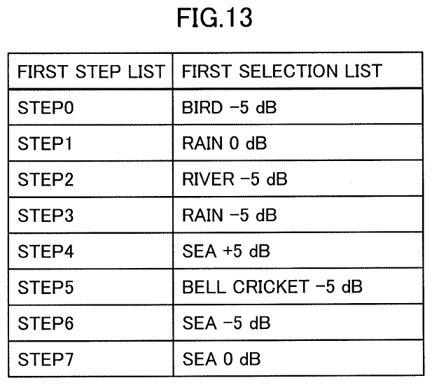

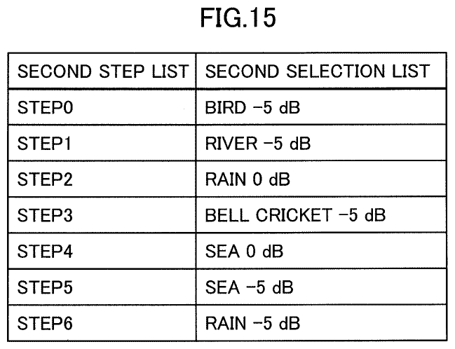

In addition, the storage unit 11 stores a first selection table (FIG. 13) and a second selection table (FIG. 15) to be described later.

The communication unit 12 is a communication circuit that connects the information processing device 1 to the network 8. The communication unit 12 receives the biological information of the user from the sensor 2. The communication unit 12 transmits, to the speaker 3, the control signal indicating the sound content. The communication unit 12 transmits, to the microphone 4, the control signal indicating the instruction to transmit the audio data to the information processing device 1. The communication unit 12 receives, from the microphone 4, the audio data indicating the audio inside the space 5.

The control unit 10 (a computer) performs overall control of the information processing device 1. The control unit 10 is configured by the computer executing an information processing program. Note that the control unit 10 may include a dedicated hardware circuit. The control unit 10 includes an acquisition unit 101 (a biological information acquisition unit, a factor acquisition unit), an estimation unit 102, a selection unit 103, and a reproduction unit 104.

The acquisition unit 101 acquires information received by the communication unit 12. For example, the acquisition unit 101 acquires the biological information of the user received by the communication unit 12 from the sensor 2.

The acquisition unit 101 acquires priority information indicating whether the relaxation degree is emphasized or the concentration degree is emphasized. Specifically, the acquisition unit 101 acquires the priority information that the communication unit 12 receives from an external device (not illustrated). Alternatively, the priority information may be stored in advance in the storage unit 11. In this case, the acquisition unit 101 acquires the priority information from the storage unit 11.

In addition, the acquisition unit 101 acquires, from the storage unit 11, the value of the factor “relaxation motivation”, the value of the factor “concentration”, and the value of the factor “preferable space” of each of the sound contents classified into the above six types and four volumes with respect to each of the sound contents classified into the above six types and four volumes.

The estimation unit 102 estimates a state of the user related to a factor (hereinafter, a user state) on the basis of the biological information of the user acquired by the acquisition unit 101.

Specifically, the estimation unit 102 estimates the relaxation degree indicating the degree of relaxation of the user as the user state related to the factor “relaxation motivation” on the basis of the biological information of the user. Furthermore, the estimation unit 102 estimates the concentration degree indicating the degree of concentration of the user as a state related to the factor “concentration” on the basis of the biological information of the user.

More specifically, the estimation unit 102 calculates a physiological index for estimating the state of the user related to the factor on the basis of the biological information of the user. The physiological index is an index used by the estimation unit 102 to derive the state of the user related to the factor.

For example, as the physiological index, a pulse wave described in Literature D1 (Japanese Patent No. 7349629), a user state described in Literature D2 (Japanese Patent Application Laid-Open No. 2020-8278), a hemoglobin concentration described in Literature D3 (International Publication No. 2012/150657), data indicating a posture of a habit described in Literature D4 (Japanese Patent Application Laid-Open No. 2020-201755), and the like can be adopted.

The estimation unit 102 estimates the user state on the basis of the calculated physiological index. Note that the user state is represented by continuous numerical values such as 0.01 to 1 (1% to 100%) and 1 to 100. Alternatively, the user state may be represented by a binary value. One example of expression of the relaxation degree of the user represented by the binary value is 1 when the user is relaxed and 0 when the user is not relaxed. One example of expression of the concentration degree of the user represented by the binary value is 1 when the user is concentrating and 0 when the user is not concentrating.

Literature D1 is known as a method for calculating the relaxation degree. The estimation unit 102 may calculate the relaxation degree of the user using the method of Literature D1. Literature D1 discloses a method of calculating a ratio LF/HF of components of an LF (a frequency band 0.05 Hz to 0.15 Hz) and an HF (a frequency band 0.15 Hz to 0.40 Hz) by performing frequency analysis on an RR interval of a second differential waveform with respect to time of the pulse wave detected by the pulse wave sensor, and calculating the relaxation degree on the basis of the LF/HF ratio. Therefore, when the method of Literature D1 is adopted, the estimation unit 102 may calculate the relaxation degree by adopting the pulse wave as the physiological index.

As methods for calculating the concentration degree, Literature D2, Literature D3, and Literature D4 are known. The estimation unit 102 may calculate the concentration degree of the user using the method of any one of Literatures D2 to D4.

For example, Literature D2 discloses a method in which an image of the user captured by a camera is input to an image processing neural network to estimate a behavior of the user such as a motion of the user, a number of blinks, a gender, and an age, and the estimated behavior of the user is input to a concentration-degree estimating neural network to calculate the concentration degree. Therefore, when the method of Literature D2 is adopted, the estimation unit 102 may calculate the concentration degree by adopting the behavior of the user estimated in the image processing network as the physiological index.

Literature D3 discloses a method of calculating a hemoglobin concentration indicating a cerebral blood flow rate from biological data measured by a near-infrared sensor and calculating the concentration degree on the basis of the hemoglobin concentration. Therefore, when the method of Literature D3 is adopted, the estimation unit 102 may calculate the concentration degree by adopting the hemoglobin concentration as the physiological index.

Literature D4 discloses a method of detecting the posture of the habit of the user during concentration from an image of the user captured by a camera, and calculating the concentration degree on the basis of the detected posture of the habit. Therefore, when the method of Literature D4 is adopted, the estimation unit 102 may calculate the concentration degree of the user by adopting, as the physiological index, data indicating the posture of the habit during concentration.

In addition, in recent years, an eyeglass type concentration-degree measuring terminal including an eye potential sensor that measures a potential on a corneal side of an eyeball and capable of detecting the concentration degree on the basis of a change in measurement potential at the time of a line of sight and blinking has appeared. The eyeglass type concentration-degree measuring terminal may be used as the sensor 2, and the estimation unit 102 may estimate, as the user state, the concentration degree included in the biological information transmitted by the sensor 2.

The selection unit 103 selects the sound content having the value of the factor according to the user state estimated by the estimation unit 102 from the 24 sound contents classified into the above six types and four volumes stored in the storage unit 11.

Specifically, in a case where the user state has not reached a target state, the selection unit 103 selects any one of the sound contents that has a higher value of the factor than that of a predetermined sound content. On the other hand, in a case where the user state exceeds the target state, the selection unit 103 selects any one of the sound contents that has a lower value of the factor than that of the predetermined sound content. Details of the selection unit 103 will be described later.

The reproduction unit 104 reproduces the sound content selected by the selection unit 103 in the space 5 where the user is present.

Specifically, the reproduction unit 104 acquires the sound content selected by the selection unit 103 from the storage unit 11. The reproduction unit 104 controls the communication unit 12 to transmit, to the speaker 3, the control signal for instructing reproduction of the sound content, the control signal including the sound content. As a result, the speaker 3 reproduces the sound content included in the control signal according to the instruction indicated by the control signal.

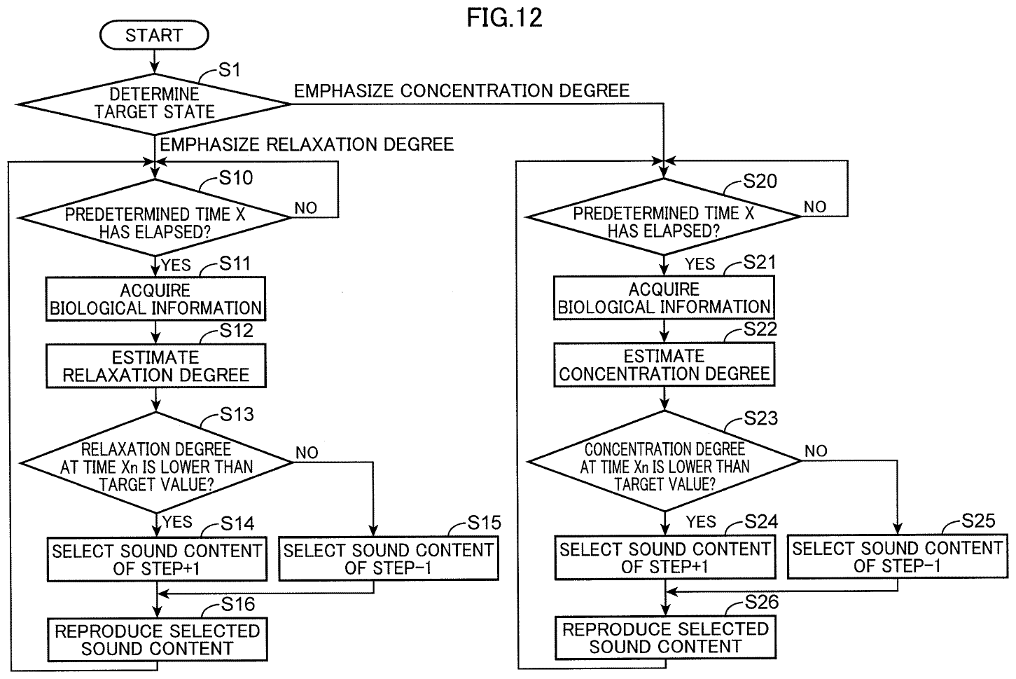

Next, processing of the information processing device 1 will be described. FIG. 12 is a flowchart illustrating the processing executed by the information processing device 1. When the information processing device 1 starts processing illustrated in FIG. 12, in step S1, the acquisition unit 101 acquires the priority information, and the selection unit 103 determines the target state (step S1).

Specifically, in step S1, when the priority information acquired by the acquisition unit 101 indicates that the relaxation degree is emphasized, the selection unit 103 sets a predetermined value (for example, 50%, 0.5, etc.) as a target value of the relaxation degree (“emphasize relaxation degree” in step S1), and the processing proceeds to step S10. Note that the priority information indicating that the relaxation degree is emphasized may include a setting value set as the target value of the relaxation degree. In this case, the selection unit 103 may set the setting value included in the priority information as the target value of the relaxation degree.

In step S10, the selection unit 103 determines whether or not predetermined time X has elapsed from a time point at which the processing proceeds to step S10 (step S10). In a case where in step S10, the selection unit 103 determines that the predetermined time X has not elapsed, the selection unit 103 causes the processing to stand by (NO in step S10). On the other hand, in a case where in step S10, the selection unit 103 determines that the predetermined time X has elapsed, the processing proceeds to step S11 (YES in step S10).

In step S11, the acquisition unit 101 acquires the biological information of the user most recently received by the communication unit 12 from the sensor 2 (step S11).

Next, in step S12, the estimation unit 102 estimates the relaxation degree of the user on the basis of the biological information acquired in step S11 (step S12).

Next, in step S13, the selection unit 103 determines whether or not the relaxation degree estimated in step S12 is lower than the target value of the relaxation degree set in step S1 (step S13).

In a case where in step S13, the selection unit 103 determines that the relaxation degree estimated in step S12 is lower than the target value of the relaxation degree set in step S1 (in a case where the target state has not been reached) (YES in step S13), the processing proceeds to step S14.

In step S14, the selection unit 103 selects one of the sound contents associated with a step number (order) next to a current step number as the sound content to be reproduced using the first selection table stored in the storage unit 11 (step S14).

Hereinafter, step S14 will be described in detail. FIG. 13 is a diagram illustrating one example of the first selection table. The first selection table is a table in which a first step list and a first selection list (list) are associated with each other. The first step list is a list in which step numbers indicating execution order of the processing are arranged in number order. The first selection list is a list in which, among the 24 sound contents classified into the six types and the four volumes stored in the storage unit 11, the sound contents each having a value of the factor “relaxation motivation” equal to or more than a reference value are arranged in order of magnitude of the value of the factor “relaxation motivation”.

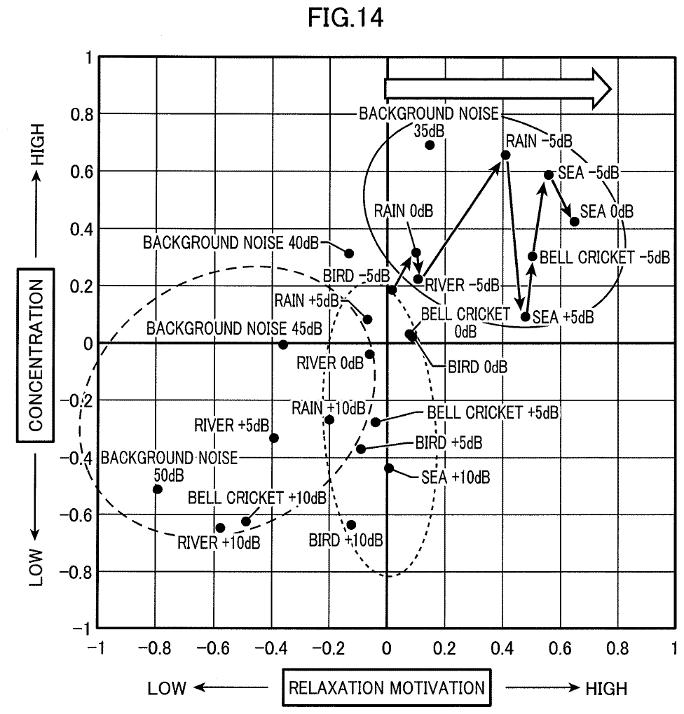

FIG. 14 is a diagram illustrating a relationship between a value of a first factor and a value of a second factor with respect to the plurality of sound contents. Specifically, FIG. 14 illustrates a relationship between the value of the factor “relaxation motivation” with respect to the 24 sound contents classified into the six types and the four volumes stored in the storage unit 11 and the value of the factor “concentration” with respect to the 24 sound contents. Note that, in FIG. 14, as with FIGS. 9 and 10, for the sound content of the type “background noise”, the volume of the sound content is described with the actual volume (for example, “35 dB (=40 dB-5 dB)”).

The first selection list illustrated in FIG. 13 is created on the basis of the values (values on a horizontal axis) of the factor “relaxation motivation” with respect to the 24 sound contents classified into the six types and the four volumes illustrated in FIG. 14, and the values (values on a vertical axis) of the factor “preferable space” with respect to the 24 sound contents classified into the six types and the four volumes illustrated in FIG. 10.

The first selection list illustrated in FIG. 13 illustrates an example in which the value of the factor “relaxation motivation” of the sound content of the type “bird” and the volume “−5 dB”, in which the value of the factor “preferable space” (FIG. 10) is the highest, is set as a reference value, and eight sound contents each having a value of the factor “relaxation motivation” equal to or more than the reference value are arranged in order of magnitude of the value of the factor “relaxation motivation” as indicated by bold arrows in FIG. 14. The sound contents included in the first selection list may not be arranged in order of magnitude of the value of the factor “concentration” as long as the sound contents are arranged in order of magnitude of at least the value of the factor “relaxation motivation”.

Note that a number of step numbers included in the first step list and a number of sound contents included in the first selection list are not limited to eight as illustrated in FIG. 13, and only need to be the same number. In addition, the reference value of the first selection list is not limited to the value of the factor “relaxation motivation” of the sound content having the highest value of the factor “preferable space” (FIG. 10). For example, the reference value of the first selection list may be a value of the factor “relaxation motivation” of the sound content of the type “background noise” and the volume “0 dB” (actually, 40 (=40-0) dB) which are the same as the base sound indicating the background noise of space 5.

In step S14, the selection unit 103 acquires the first selection table (FIG. 13) from the storage unit 11. The selection unit 103 acquires a step number (for example, “STEP1”) next to a current step number (for example, “STEP0”) from the acquired first step list of the first selection table.

In the first selection list (FIG. 13) of the first selection table acquired from the storage unit 11, the selection unit 103 selects, as the sound content to be reproduced, the sound content (for example, “rain 0 dB” (the sound content of the type “rain” and the volume “0 dB”)) associated with the acquired next step number (for example, “STEP 1”) having the higher value of the factor “relaxation motivation” than the sound content (a predetermined sound content) associated with the current step number (for example, “STEP0”).

When selecting the sound content to be reproduced, the selection unit 103 updates the current step number (for example, “STEP0”) with the acquired next step number (for example, “STEP1”). Note that in a case where step S14 is performed first after start of the processing illustrated in FIG. 12, the selection unit 103 sets the current step number to “STEP0”.

On the other hand, in step S13, in a case where the selection unit 103 determines that the relaxation degree estimated in step S12 is higher than the target value of the relaxation degree set in step S1 (in a case where the relaxation degree exceeds the target state) (NO in step S13), the processing proceeds to step S15.

In step S15, by using the first selection table stored in the storage unit 11, the selection unit 103 selects, as the sound content to be reproduced, one sound content associated with a step number before the current step number (step S15).

Hereinafter, step S15 will be described in detail. In step S15, the selection unit 103 acquires the first selection table (FIG. 13) from the storage unit 11 as in step S14. The selection unit 103 acquires, from the first step list of the acquired first selection table, the step number (for example, “STEP0”) before the current step number (for example, “STEP1”).

In the first selection list (FIG. 13) of the first selection table acquired from the storage unit 11, the selection unit 103 selects, as the sound content to be reproduced, the sound content (for example, “bird-5 dB” (the sound content of the type “bird” and the volume “−5 dB”)) associated with the acquired previous step number (for example, “STEP0”) having a lower value of the factor “relaxation motivation” than the sound content (the predetermined sound content) associated with the current step number (for example, “STEP1”).

When selecting the sound content to be reproduced, the selection unit 103 updates the current step number (for example, “STEP1”) with the acquired previous step number (for example, “STEP0”).

Note that in a case where step S15 is performed first after the start of the processing illustrated in FIG. 12, the selection unit 103 sets the current step number to “STEP0”. In this case, in step S15, the selection unit 103 selects, as the sound content to be reproduced, the sound content associated with the current step number “STEP0” in the first step list of the first selection table.

In the case where the sound content to be reproduced is selected in step S14, step S16 is performed. In addition, in the case where the sound content to be reproduced is selected in step S15, step S16 is also performed.

In step S16, the reproduction unit 104 reproduces the sound content to be reproduced selected in step S14 or step S15 in the space 5 where the user is present (step S16).

As described above, in steps S14 and S15, the selection unit 103 selects the sound content to be reproduced, using the first selection table. Therefore, the sound content to be reproduced in the space 5 where the user is present can be efficiently selected by limiting to the sound contents each having the value of the factor “relaxation motivation” equal to or more than the reference value, and following the arrangement order in the list. Furthermore, in the case where the reference value is the value of the factor “relaxation motivation” of the sound content having the highest value of the factor “preferable space” (FIG. 10), after the space 5 where the user is present is set to a preferable state, the relaxation degree of the user can be brought close to the target state.

Note that the sound contents included in the first selection list may be arranged in order of magnitude of the value of the factor “relaxation motivation” and in order of magnitude of the value of the factor “concentration”. In this case, it is possible to form a sound environment suitable for improving performance of the user by improving the concentration degree while improving the relaxation degree of the user. Alternatively, the sound contents included in the first selection list may be arranged in the order of the magnitude of the value of the factor “relaxation motivation” and arranged in reverse order of the magnitude of the value of the factor “concentration” (so that the value becomes smaller). In this case, it is possible to form a sound environment suitable for the rest of the user by reducing the concentration degree while improving the relaxation degree of the user. That is, the sound contents included in the first selection list are arranged at least in order of magnitude of the value of the factor “relaxation motivation”, and are changed according to the value of the factor “concentration”, whereby a sound environment according to the state of the user and the use of the space can be formed.

On the other hand, in step S1, in a case where the priority information acquired by the acquisition unit 101 indicates that the concentration degree is emphasized, the selection unit 103 sets a predetermined value (for example, 80%, 0.8, etc.) as a target value of the concentration degree (“emphasis on the concentration degree” in step S1), and the processing proceeds to step S20. Note that the priority information indicating that the concentration degree is emphasized may include a setting value set as the target value of the concentration degree. In this case, the selection unit 103 may set the setting value included in the priority information as the target value of the concentration degree.

In step S20, as in step S10, the selection unit 103 determines whether or not the predetermined time X has elapsed from a time point at which the processing proceeds to step S20 (step S20). In a case where it is determined in step S20 that the predetermined time X has not elapsed, the selection unit 103 causes the processing to stand by (NO in step S20), and in a case where it is determined that the predetermined time X has elapsed, the processing proceeds to step S21 (YES in step S20).

In step S21, as in step S11, the acquisition unit 101 acquires the biological information of the user most recently received by the communication unit 12 from the sensor 2 (step S21).

Next, in step S22, the estimation unit 102 estimates the concentration degree of the user on the basis of the biological information acquired in step S21 (step S22).

Next, in step S23, the selection unit 103 determines whether or not the concentration degree estimated in step S22 is lower than the target value of the concentration degree set in step S1 (step S23).

In step S23, in a case where the selection unit 103 determines that the concentration degree estimated in step S22 is lower than the target value of the concentration degree set in step S1 (in a case where the target state has not been reached) (YES in step S23), the processing proceeds to step S24.

In step S24, by using the second selection table stored in the storage unit 11, the selection unit 103 selects, as the sound content to be reproduced, one sound content associated with the step number next to the current step number (step S24).

Hereinafter, step S24 will be described in detail. FIG. 15 is a diagram illustrating an example of the second selection table. The second selection table is a table in which a second step list in which step numbers are arranged in numerical order is associated with a second selection list (list). The second selection list is a list in which, among the 24 sound contents classified into the six types and the four volumes stored in the storage unit 11, the sound contents each having the value of the factor “concentration” equal to or more than a reference value are arranged in order of magnitude of the value of the factor “concentration”.

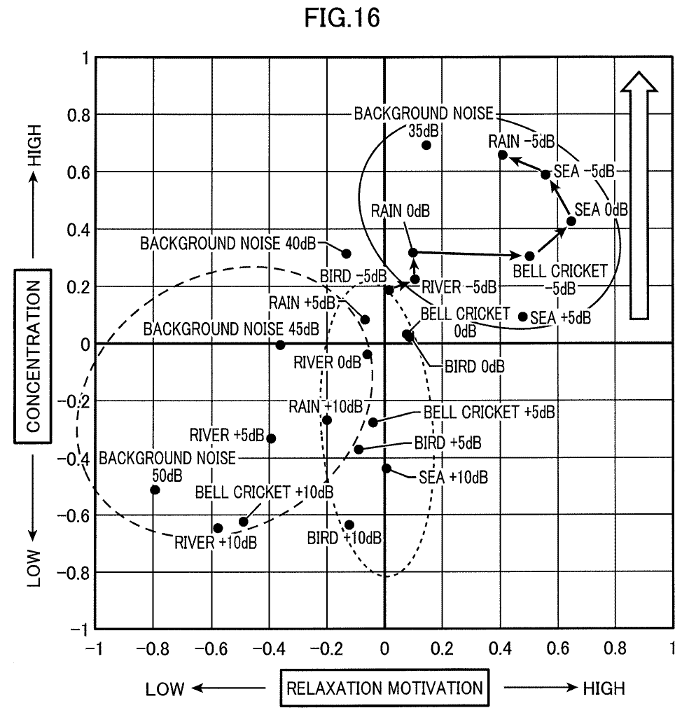

FIG. 16 is a diagram illustrating a relationship between the value of the first factor and the value of the second factor with respect to the plurality of sound contents. Specifically, FIG. 16 illustrates a relationship between the value of the factor “relaxation motivation” with respect to the 24 sound contents classified into the six types and the four volumes stored in the storage unit 11, and the value of the factor “concentration” with respect to the 24 sound contents. Note that, in FIG. 16, as in FIGS. 9 and 10, with respect to the sound content of the type “background noise”, the volume of the sound content is described with the actual volume (for example, “35 dB (=40 dB−5 dB)”).

The second selection list illustrated in FIG. 15 is created on the basis of the values (values on a vertical axis) of the factor “concentration” with respect to the 24 sound contents classified into the six types and the four volumes illustrated in FIG. 16, and the values (values on the vertical axis) of the factor “preferable space” with respect to the 24 sound contents classified into the six types and the four volumes illustrated in FIG. 10.

The second selection list illustrated in FIG. 15 illustrates an example in which the value of the factor “concentration” of the sound content of the type “bird” and the volume “−5 dB”, in which the value of the factor “preferable space” (FIG. 10) is the highest, is set as the reference value, and by excluding some sound contents, seven sound contents each having a value of the factor “concentration” equal to or more than the reference value are arranged in order of magnitude of the value of the factor “concentration” as indicated by bold arrows in FIG. 16. The sound contents included in the second selection list may not be arranged in order of magnitude of the value of the factor “relaxation motivation” as long as the sound contents are arranged at least in order of magnitude of the value of the factor “concentration”.

Note that a number of step numbers included in the second step list and a number of sound contents included in the second selection list are not limited to seven as illustrated in FIG. 15, and only need to be the same number. In addition, the reference value of the second selection list is not limited to the value of the factor “concentration” of the sound content having the highest value of the factor “preferable space” (FIG. 10). For example, the reference value of the second selection list may be a value of the factor “concentration” of the sound content of the type “background noise” and the volume “0 dB” (actually, 40 (=40−0) dB) which are the same as the base sound indicating the background noise of space 5.

In step S24, the selection unit 103 acquires the second selection table (FIG. 15) from the storage unit 11. The selection unit 103 acquires a step number (for example, “STEP1”) next to a current step number (for example, “STEP0”) from the acquired second step list of the second selection table.

In the second selection list (FIG. 15) of the second selection table acquired from the storage unit 11, the selection unit 103 selects, as the sound content to be reproduced, the sound content (for example, “river −5 dB” (the sound content of the type “river” and the volume “−5 dB”)) associated with the acquired next step number (for example, “STEP1”) having the higher value of the factor “concentration” than that of the sound content (a predetermined sound content) associated with the current step number (for example, “STEP0”).

When selecting the sound content to be reproduced, the selection unit 103 updates the current step number (for example, “STEP0”) with the acquired next step number (for example, “STEP1”). Note that in a case where step S24 is performed first after the start of the processing illustrated in FIG. 12, the selection unit 103 sets the current step number to “STEP0”.

On the other hand, in step S23, in a case where the selection unit 103 determines that the concentration degree estimated in step S22 is higher than the target value of the concentration degree set in step S1 (in a case where the concentration degree exceeds the target state) (NO in step S23), the processing proceeds to step S25.

In step S25, by using the second selection table stored in the storage unit 11, the selection unit 103 selects, as the sound content to be reproduced, one sound content associated with the step number before the current step number (step S25).

Hereinafter, step S25 will be described in detail. In step S25, the selection unit 103 acquires the second selection table (FIG. 15) from the storage unit 11 as in step S24. The selection unit 103 acquires the step number (for example, “STEP0”) before the current step number (for example, “STEP1”) from the second step list of the acquired second selection table.

In the second selection list (FIG. 15) of the second selection table acquired from the storage unit 11, the selection unit 103 selects, as the sound content to be reproduced, the sound content (for example, “bird-5 dB” (the sound content of the type “bird” and the volume “−5 dB”)) associated with the acquired previous step number (for example, “STEP0”) having the lower value of the factor “concentration” than that of the sound content (the predetermined sound content) associated with the current step number (for example, “STEP1”).

When selecting the sound content to be reproduced, the selection unit 103 updates the current step number (for example, “STEP1”) with the acquired previous step number (for example, “STEP0”).

Note that in a case where step S25 is performed first after the start of the processing illustrated in FIG. 12, the selection unit 103 sets the current step number to “STEP0”. In this case, in step S25, the selection unit 103 selects, as the sound content to be reproduced, the sound content associated with the current step number “STEP0” in the second step list of the second selection table.

In the case where the sound content to be reproduced is selected in step S24, step S26 is performed. In addition, in the case where the sound content to be reproduced is selected in step S25, step S26 is also performed.

In step S26, the reproduction unit 104 reproduces the sound content to be reproduced selected in step S24 or step S25 in the space 5 where the user is present (step S26).

As described above, in steps S24 and S25, the selection unit 103 selects the sound content to be reproduced, using the second selection table. Therefore, the sound content to be reproduced in the space 5 where the user is present can be efficiently selected by limiting to the sound contents each having the value of the factor equal to or more than the reference value, and following the arrangement order in the list. Furthermore, in the case where the reference value is the value of the factor “concentration” of the sound content having the highest value of the factor “preferable space” (FIG. 10), after the space 5 where the user is present is set to a preferable state, the concentration degree of the user can be brought close to the target state.

Note that the sound contents included in the second selection list may be arranged in order of magnitude of the value of the factor “concentration” and in order of magnitude of the value of the factor “relaxation motivation”. In this case, it is possible to form a sound environment suitable for improving the performance of the user by improving the relaxation degree while improving the concentration degree of the user. Alternatively, the sound contents included in the second selection list may be arranged in the order of the magnitude of the value of the factor “concentration” and arranged in reverse order of the magnitude of the value of the factor “relaxation motivation” (so that the value becomes smaller). In this case, it is possible to form a sound environment suitable for improving the concentration degree and a tension degree of the user by lowering the relaxation degree while improving the concentration degree of the user. That is, the sound contents included in the second selection list are arranged at least in order of the magnitude of the value of the factor “concentration”, and are changed according to the value of the factor “relaxation motivation”, whereby a sound environment according to the state of the user and the use of the space can be formed.

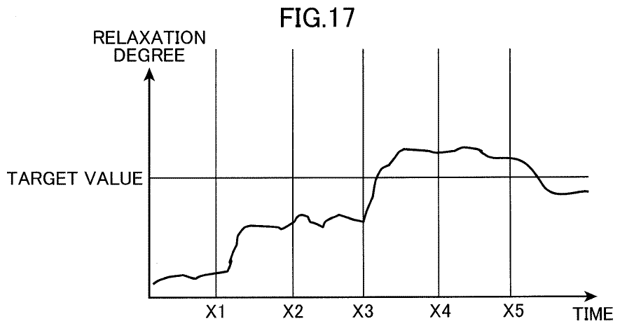

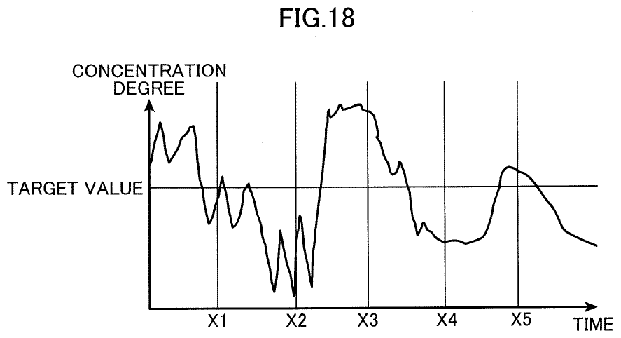

Next, an embodiment of the processing illustrated in FIG. 12 will be described with reference to FIGS. 17 and 18. FIG. 17 is a diagram illustrating one example of a time-series change in the relaxation degree of the user. A horizontal axis in FIG. 17 represents elapsed time from the start of the processing illustrated in FIG. 12, and a vertical axis represents the relaxation degree estimated from the biological information transmitted from the sensor 2 to the information processing device 1.

It is assumed that the processing illustrated in FIG. 12 is started, that in step S1, the priority information acquired by the acquisition unit 101 indicates that the relaxation degree is emphasized, and that the selection unit 103 sets the target value of the relaxation degree. In this case, every time the predetermined time X elapses after the processing illustrated in FIG. 12 is started, the acquisition processing of the biological information in step S11, the estimation processing of the relaxation degree in step S12, the selection processing of the sound content to be reproduced in steps S13 to S15, and the reproduction processing of the sound content in step S16 are repeated.

As illustrated in FIG. 17, in a case where the relaxation degree estimated in step S12 is equal to or less than the target value at a time X1 when the predetermined time X elapsed first, step S14 (FIG. 12) is performed. In step S14, the sound content having the higher value of the factor “relaxation motivation” than that of the sound content associated with the current step number, which is associated with the step number next to the current step number in the first selection list (FIG. 13) of the first selection table, is selected as the sound content to be reproduced, and the sound content is reproduced in step S16. As a result, as illustrated in FIG. 17, after the time X1, the relaxation degree of the user related to the factor “relaxation motivation” is improved.

Similarly, steps S14 and S16 are also performed at a time X2 when the predetermined time X elapsed from the time X1 and a time X3 when the predetermined time X elapsed from the time X2. As a result, the sound content having the higher value of the factor “relaxation motivation” than the value of the sound content associated with the current step number is reproduced, and the relaxation degree of the user related to the factor “relaxation motivation” is also improved after the time X2 and the time X3.

Thereafter, in a case where the relaxation degree estimated in step S12 exceeds the target value at a time X4 when the predetermined time X elapsed from the time X3, step S15 (FIG. 12) is performed. In step S15, the sound content having the lower value of the factor “relaxation motivation” than that of the sound content associated with the current step number, which is associated with the step number before the current step number in the first selection list (FIG. 13) of the first selection table, is selected as the sound content to be reproduced, and the sound content is reproduced in step S16. As a result, as illustrated in FIG. 17, after the time X4, the relaxation degree of the user related to the factor “relaxation motivation” is suppressed.

Similarly, steps S15 and S16 are also performed at a time X5 when the predetermined time X elapsed from the time X4. As a result, the sound content having the lower value of the factor “relaxation motivation” than the value of the sound content associated with the current step number is reproduced, and the relaxation degree of the user related to the factor “relaxation motivation” is suppressed after the time X5.

FIG. 18 is a diagram illustrating one example of a time-series change in the concentration degree of the user. A horizontal axis in FIG. 18 represents elapsed time from the start of the processing illustrated in FIG. 12, and a vertical axis represents the concentration degree estimated from the biological information transmitted from the sensor 2 to the information processing device 1.

It is assumed that the processing illustrated in FIG. 12 is started, that in step S1, the priority information acquired by the acquisition unit 101 indicates that the concentration degree is emphasized, and that the selection unit 103 sets the target value of the concentration degree. In this case, every time the predetermined time X elapses after the processing illustrated in FIG. 12 is started, the acquisition processing of the biological information in step S21, the estimation processing of the concentration degree in step S22, the selection processing of the sound content to be reproduced in steps S23 to S25, and the reproduction processing of the sound content in step S26 are repeated.

As illustrated in FIG. 18, in a case where the concentration degree estimated in step S22 is equal to or less than the target value at the time X1 when the predetermined time X elapsed first, step S24 (FIG. 12) is performed. In step S24, the sound content having the higher value of the factor “concentration” than that of the sound content associated with the current step number, which is associated with the step number next to the current step number in the second selection list (FIG. 15) of the second selection table, is selected as the sound content to be reproduced, and the sound content is reproduced in step S26. As a result, as illustrated in FIG. 18, after the time X1, the concentration degree of the user related to the factor “concentration” is improved.

However, thereafter, in a case where the concentration degree of the user decreases until the time X2 when the predetermined time X elapsed from the time X1, and the concentration degree estimated in step S22 at the time X2 is equal to or less than the target value, steps S24 and S26 are performed. As a result, the sound content having the higher value of the factor “concentration” than the value of the sound content associated with the current step number is reproduced, and the concentration degree of the user related to the factor “concentration” is improved after the time X2.

Thereafter, in a case where the concentration degree estimated in step S22 exceeds the target value at the time X3 when the predetermined time X elapsed from the time X2, step S25 is performed. In step S25, the sound content having the lower value of the factor “concentration” than that of the sound content associated with the current step number, which is associated with the step number before the current step number in the second selection list (FIG. 15) of the second selection table, is selected as the sound content to be reproduced, and the sound content is reproduced in step S26. As a result, as illustrated in FIG. 18, after the time X3, the concentration degree of the user related to the factor “concentration” is suppressed. Thereafter, in a case where the concentration degree of the user decreases until the time X4 when the predetermined time X elapsed from the time X3, and the concentration degree estimated in step S22 at the time X4 is equal to or less than the target value, steps S24 and S26 are performed. As a result, the sound content having the higher value of the factor “concentration” than the value of the sound content associated with the current step number is reproduced, and the concentration degree of the user related to the factor “concentration” is improved after the time X4.

Thereafter, in a case where the concentration degree estimated in step S22 exceeds the target value at the time X5 when the predetermined time X elapsed from the time X4, step S25 is performed. In step S25, the sound content having the lower value of the factor “concentration” than that of the sound content associated with the current step number is selected as the sound content to be reproduced, and the sound content is reproduced in step S26. As a result, as illustrated in FIG. 18, after the time X5, the concentration degree of the user related to the factor “concentration” is suppressed.

As described above, according to the present first embodiment, in the case where the relaxation degree (or the concentration degree) of the user has not reached the target value, the sound content having the higher value of the factor than that of the sound content currently being reproduced is reproduced, and in the case where the relaxation degree (or the concentration degree) of the user has exceeded the target value, the sound content having the lower value of the factor than that of the sound content currently being reproduced is reproduced. Therefore, in the present configuration, the sound environment corresponding to the relaxation degree (or the concentration degree) of the user is formed in the space 5 where the user is present, and the relaxation degree (or the concentration degree) of the user can be brought close to the target state.

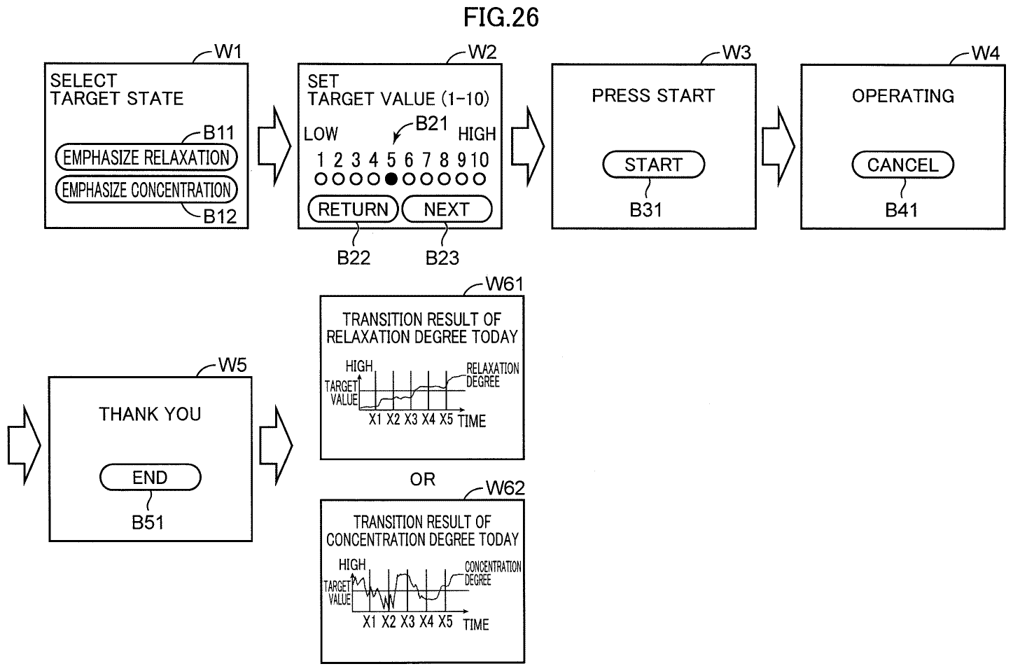

Next, one example of screens related to the processing illustrated in FIG. 12 will be described, the screens being displayed on a display device (a display) included in an external device such as a mobile terminal, a smartphone, or a personal computer, which is used by the user or an administrator of the information processing system 100. FIG. 26 is a diagram illustrating one example of the screens related to the processing illustrated in FIG. 12.

A screen W1 is an operation screen for selecting whether to emphasize the relaxation degree or the concentration degree. The screen W1 includes a button B11 for selecting to emphasize the relaxation degree and a button B12 for selecting to emphasize the concentration degree. When the button B11 or the button B12 is selected, the external device displays a screen W2 instead of the screen W1.

The screen W2 is an operation screen for setting the target value of the relaxation degree of relaxation or the concentration degree. The screen W2 includes a radio button (an option button) B21, a return button B22, and a next button B23 for selecting any one of 1 to 10 as the target value. FIG. 26 illustrates an example in which the radio button B21 corresponding to 5 is selected on the screen W2 and 5 is set as the target value.

Note that when the screen W2 is displayed instead of the screen W1, the radio button B21 corresponding to a predetermined value of any one of 1 to 10 may be automatically selected.

Further, the values of 1 to 10 displayed on the screen W2 are examples of the target value, and the value selectably displayed on the screen W2 and the target value to be set may not coincide with each other. For example, when the radio button B21 corresponding to 2 is selected on the screen W2, 2 may be set as the target value, and when the radio button B21 corresponding to 10 is selected, 10 may be set as the target value. Alternatively, when the radio button B21 corresponding to 2 is selected, 4 may be set as the target value, and when the radio button B21 corresponding to 10 is selected, 8 may be set as the target value. Alternatively, when the radio button B21 corresponding to 2 is selected, 4 or 40% may be set as the target value, and when the radio button B21 corresponding to 10 is selected, 8 or 80% may be set as the target value.

When the return button B22 is pressed, the external device displays the screen W1 instead of the screen W2. When the next button B23 is pressed, the external device displays a screen W3 instead of the screen W2. The screen W3 is an operation screen for transmitting information indicating contents selected on the screen W1 and the screen W2 to the information processing device 1. The screen W3 includes a start button B31.

When the button B11 is pressed on the screen W1 and the start button B31 is pressed, the external device transmits, to the information processing device 1, the priority information indicating that the relaxation degree is emphasized and the target value set on the screen W2. On the other hand, when the button B12 is pressed on the screen W1 and the start button B31 is pressed, the external device transmits, to the information processing device 1, the priority information indicating that the concentration degree is emphasized and the target value set on the screen W2. In response to this, when the communication unit 12 receives the priority information and the target value from the external device, the acquisition unit 101 acquires the priority information and the target value. Then, the control unit 10 starts the processing illustrated in FIG. 12. After transmitting the priority information and the target value, the external device displays a screen W4 instead of the screen W3.

The screen W4 is a screen indicating that the processing illustrated in FIG. 12 is being executed. The screen W4 includes a cancel button B41 for canceling the processing illustrated in FIG. 12. When the cancel button B41 is pressed, the external device transmits, to the information processing device 1, information (hereafter, cancel instruction information) instructing to cancel the processing illustrated in FIG. 12. In response to this, when the communication unit 12 receives the cancel instruction information from the external device, the control unit 10 ends the processing illustrated in FIG. 12 being executed.

Upon ending the processing illustrated in FIG. 12 being executed, the control unit 10 controls the communication unit 12 to transmit, to the external device, information (hereafter, processing end information) indicating that the processing illustrated in FIG. 12 has been ended. Upon receiving the processing end information from the information processing device 1, the external device displays a screen W5 for guiding that the processing illustrated in FIG. 12 is ended. The screen W5 includes an end button B51. When the end button B51 is pressed, the external device hides the screen W5.

Note that when the start button B31 is pressed on the screen W3, the external device may hide the screen W3 so as not to display the screen W4. In this case, a predetermined operation for cancelling the processing illustrated in FIG. 12 may be performed in the external device, and the screen W4 may be displayed when the operation is performed.

Furthermore, after the processing illustrated in FIG. 12 is ended, temporal transition of the relaxation degree or the concentration degree of the user in the processing may be displayed on the external device.

Specifically, the control unit 10 may store the relaxation degree of the user estimated in step S12 of the processing illustrated in FIG. 12 or the concentration degree of the user estimated in step S22 in the storage unit 11 in association with a current time. In the external device, in a case where a predetermined operation for gazing at the temporal transition of the user state in the processing illustrated in FIG. 12 is performed by the user or the administrator after the screen W5 is hidden, information (hereinafter, display instruction information) instructing display of the user state may be transmitted to the information processing device 1.

When the communication unit 12 receives the display instruction information, the control unit 10 may acquire the current time from the time point when the processing illustrated in FIG. 12 is started to a time point when the communication unit 12 receives the display instruction information, and the relaxation degree or the concentration degree of the user associated with the current time from the storage unit 11, and may return the acquired information to the external device.

In response to this, the external device may display a screen displaying, in association with the current time, the relaxation degree or the concentration degree of the user, which are received from the information processing device 1 after the transmission of elapse display information. A screen W61 illustrated in FIG. 26 illustrates one example of a screen displaying the relaxation degree of the user in association with the current time, and a screen W62 illustrated in FIG. 26 illustrates one example of a screen displaying the concentration degree of the user in association with the current time.

### Second Embodiment

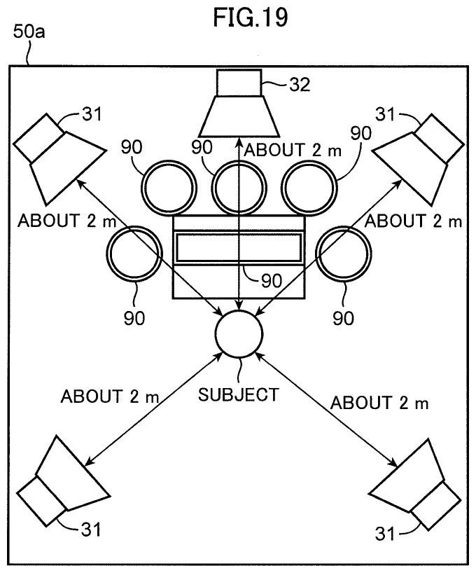

In the first embodiment, the example has been described in which the sound content according to the state of the user related to the factor is reproduced on the basis of a value of a factor of each of the 24 sound contents classified into the six types and the four volumes obtained from the subjective evaluation experiment for the office workers in the anechoic chamber 50 illustrated in FIG. 1. FIG. 19 is a view illustrating one example of another experimental environment. In the second embodiment, an example will be described in which the sound content according to the state of the user related to the factor is reproduced on the basis of the value of the factor of each of the 24 sound contents obtained from a subjective evaluation experiment for office worker similar to the above in an anechoic chamber 50a illustrated in FIG. 19. Hereinafter, the above-described subjective evaluation experiment performed in the anechoic chamber 50 illustrated in FIG. 1 will be referred to as a first experiment, and the subjective evaluation experiment similar to the above performed in the anechoic chamber 50a illustrated in FIG. 19 will be referred to as a second experiment.

The second experiment was performed for two days in the anechoic chamber 50a illustrated in FIG. 19, similarly to the first experiment. Subjects were 16 office workers (eight males and eight females) in their thirties to sixties. In the center of the anechoic chamber 50a, similarly to the first experiment, a desk for allowing each of the subjects to perform work of filling out a questionnaire using a tablet terminal was disposed. In addition, on and around the desk, planting 90 such as a foliage plant was provided so as to be within a field of view of the subject. Accordingly, unlike in the first experiment, four speakers 31 for reproducing the sound content indicating the base sound as the background noise were disposed so as to be separated from the subject by 2m in diagonal directions. Similarly to the first experiment, one speaker 32 that reproduces the sound content indicating the natural sound to be added to the base sound was disposed at a position 2m away from the subject in a front direction.

Similarly to the first experiment, using the 24 sound contents classified into the six types and the four volumes illustrated in FIG. 3, the sound content indicating the base sound was reproduced by the four speakers 31, and the sound content indicating the natural sound were reproduced by the speaker 32 such that the sound environment inside the anechoic chamber 50a satisfied each of the 24 sound environmental conditions illustrated in FIG. 2.

Similarly to the first experiment, the same questionnaire as in the first experiment was conducted for the subject. When all the subjects finished their questionnaires, similarly to the first experiment, the factor analysis and the cluster analysis were performed by using the statistical analysis tool on evaluation results of all the subjects for the 10 evaluation items excluding the comprehensive evaluation items “preferability”, “ease of working”, and “comfort” with respect to each of the 24 sound environments formed inside the anechoic chamber 50a.

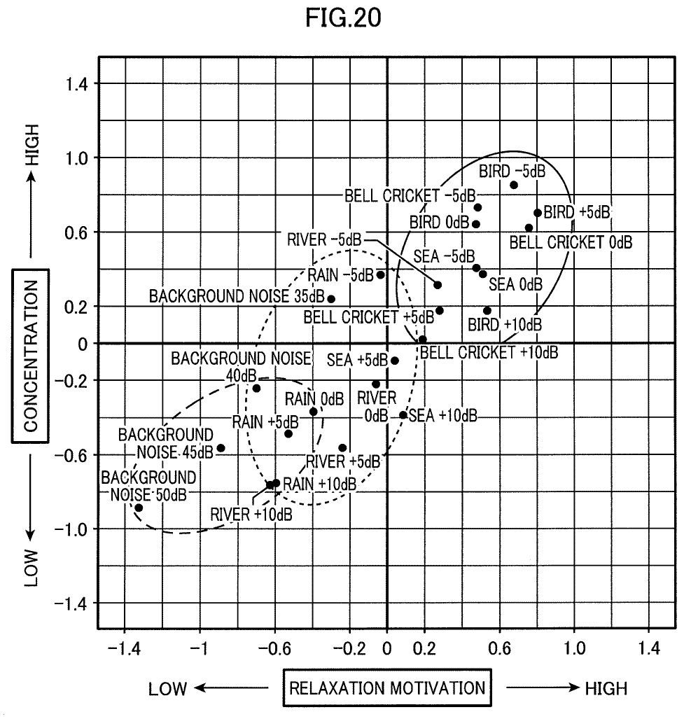

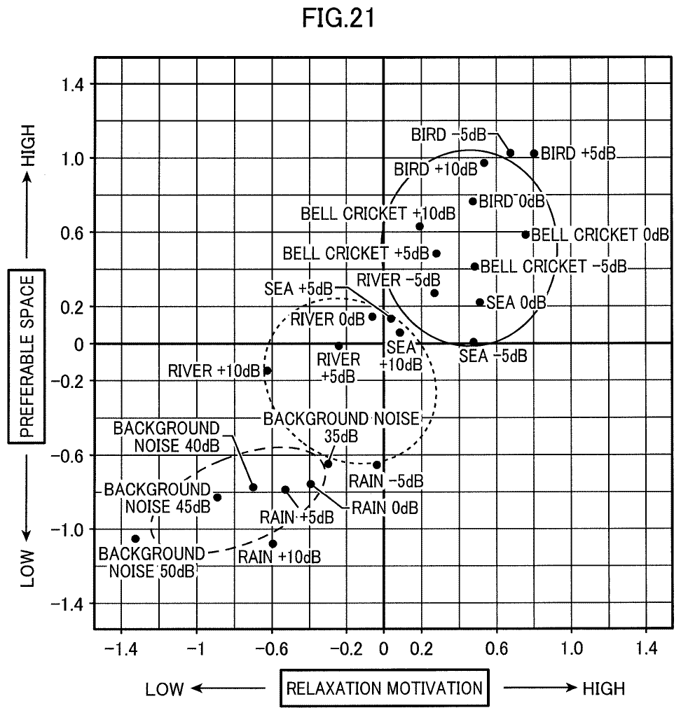

FIGS. 20 and 21 are diagrams illustrating examples of results of the factor analysis and the cluster analysis of the other evaluation results. Similarly to FIG. 9, FIG. 20 illustrates a result of arranging the evaluation results for the sound environments with the factor score of the factor “relaxation motivation” on a horizontal axis and the factor score of the factor “concentration” on a vertical axis, and further classifying the evaluation results into three groups by the cluster analysis.

Similarly to FIG. 10, FIG. 21 illustrates a result of arranging the evaluation results with respect to the sound environments with the factor score of the factor “relaxation motivation” on a horizontal axis and the factor score of the factor “preferable space” on a vertical axis, and further classifying the evaluation results into three groups by the cluster analysis.

Arrangement positions of the three groups classified by the cluster analysis in FIGS. 20 and 21 are significantly different from those in FIGS. 9 and 10. As a result of considering the arrangement positions of the three groups in FIGS. 20 and 21, the present inventors have found that, by providing the planting 90, the values of the factors are increased in a case where the sound contents of the types “bird” and “bell cricket” in which a sense of harmony is high when the planting 90 is viewed are reproduced.

Therefore, in the second embodiment, on the basis of the above knowledge, when the planting 90 is provided inside the space 5 where the user is present, a third selection table to be described later is used instead of the first selection table in steps S14 and S15 (FIG. 12), and a fourth selection table to be described later is used instead of the second selection table in steps S24 and S25 (FIG. 12).

Specifically, the third selection table and the fourth selection table are stored in the storage unit 11. In addition, the storage unit 11 stores planting information indicating whether or not the planting 90 is provided inside the space 5 where the user is present. The selection unit 103 refers to the planting information stored in the storage unit 11 when performing steps S14, S15, S24, and S25.

In steps S14 and S15, in a case where the planting information indicates that the planting 90 is provided inside the space 5 where the user is present, the selection unit 103 selects the sound content using the third selection table instead of the first selection table. In steps S24 and S25, in the case where the planting information indicates that the planting 90 is provided inside the space 5 where the user is present, the selection unit 103 selects the sound content using the fourth selection table instead of the second selection table.

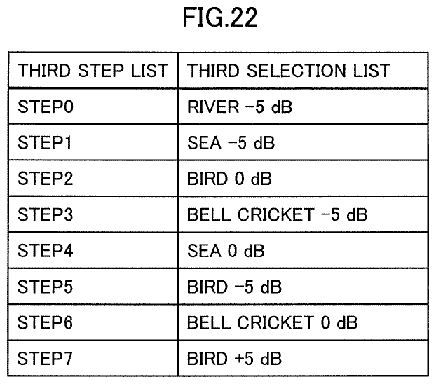

FIG. 22 is a diagram illustrating one example of the third selection table. The third selection table has a structure similar to the first selection table (FIG. 13), and is a table in which a third step list corresponding to the first step list of the first selection table and a third selection list (list) corresponding to the first selection list of the first selection table are associated with each other. Similarly to the first selection list, the third selection list is a list in which, among the 24 sound contents classified into the six types and the four volumes stored in the storage unit 11, sound contents in which the value (an adjustment value of the factor) of the factor “relaxation motivation” in the case where the planting 90 is provided inside the space 5 is equal to or more than a reference value are arranged in order of magnitude of the value (the adjustment value of the factor) of the factor “relaxation motivation” in the case where the planting 90 is provided inside the space 5.

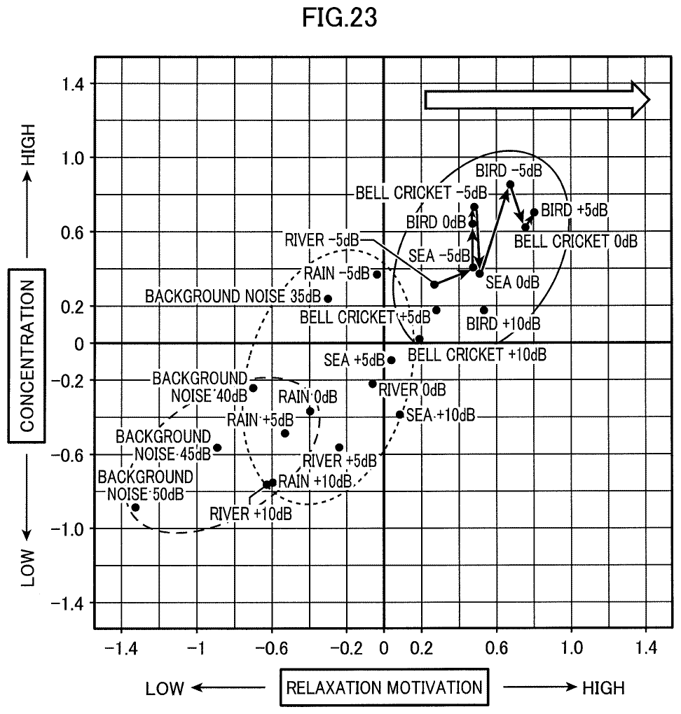

FIG. 23 is a diagram illustrating a relationship between the value of the first factor and the value of the second factor with respect to the plurality sound contents. Specifically, FIG. 23 illustrates a relationship between the value of the factor “relaxation motivation” with respect to the 24 sound contents classified into the six types and the four volumes in the case where the planting 90 is provided inside the space 5, and the value of the factor “concentration” with respect to each of the 24 sound contents in the case where the planting 90 is provided inside the space 5. Note that, in FIG. 23, as with FIGS. 9 and 10, with respect to the sound content of the type “background noise”, the volume of the sound content is described with the actual volume (for example, “35 dB (=40 dB−5 dB)”).

The third selection list illustrated in FIG. 22 is created on the basis of the values (values on a horizontal axis) of the factor “relaxation motivation” and the values (values on a vertical axis) of the factor “concentration” with respect to the 24 sound contents classified into the six types and the four volumes illustrated in FIG. 23, and the values (values on a vertical axis) of the factor “preferable space” with respect to the 24 sound contents classified into the six types and the four volumes illustrated in FIG. 21.

In the third selection list illustrated in FIG. 22, the value of the factor “relaxation motivation” of the sound content of the type “river” and the volume “−5 dB”, in which the value of the factor “preferable space” (FIG. 21) is higher than a median value, and the value of the factor “relaxation motivation” and the value of the factor “concentration” (FIG. 23) are around median values, is used as a reference value. The third selection list illustrated in FIG. 22 illustrates an example in which eight sound contents in which the value of the factor “relaxation motivation” is equal to or more than the reference value are arranged in order of magnitude of the value of the factor “relaxation motivation” as indicated by bold arrows in FIG. 23.

Note that the number of step numbers included in the third step list and the number of sound contents included in the third selection list are not limited to eight as illustrated in FIG. 22, and only need to be the same number. Furthermore, the reference value of the third selection list is not limited to the above, and may be, for example, a value of the factor “relaxation motivation” of the sound content of the type “background noise” and the volume “0 dB” (actually, 40 (=40−0) dB) that are the same as the base sound indicating the background noise of space 5.

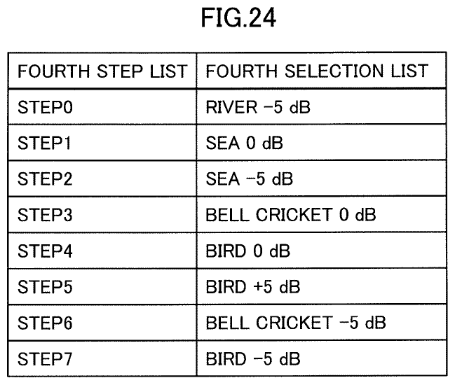

FIG. 24 is a diagram illustrating one example of the fourth selection table. The fourth selection table has a structure similar to the second selection table (FIG. 15), and is a table in which a fourth step list corresponding to the second step list of the second selection table and a fourth selection list (list) corresponding to the second selection list of the second selection table are associated with each other. Similarly to the second selection list, the fourth selection list is a list in which, among the 24 sound contents classified into the six types and the four volumes stored in the storage unit 11, sound contents in which the value (an adjustment value of the factor) of the factor “concentration” in the case where the planting 90 is provided inside the space 5 is equal to or more than a reference value are arranged in order of magnitude of the value (the adjustment value of the factor) of the factor “concentration” in the case where the planting 90 is provided inside the space 5.

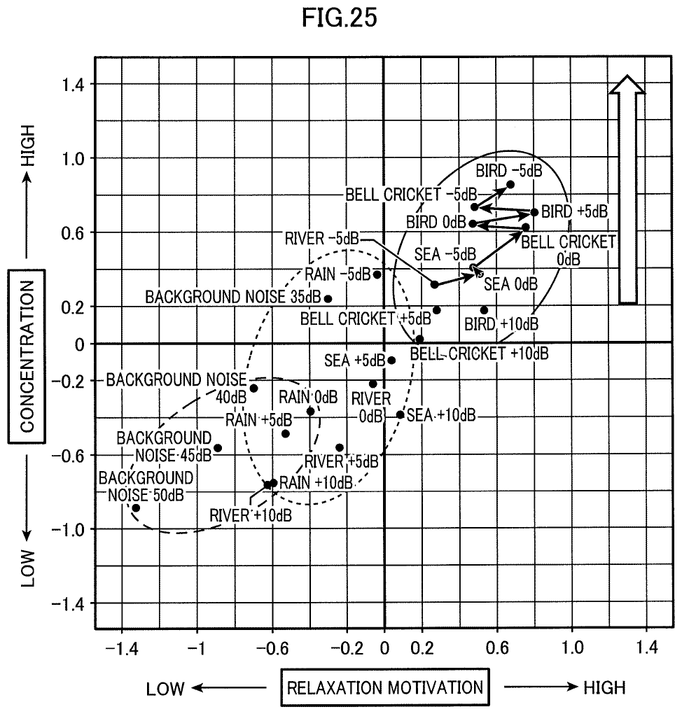

FIG. 25 is a diagram illustrating a relationship between the value of the first factor and the value of the second factor with respect to the plurality sound contents. Specifically, FIG. 25 illustrates a relationship between the value of the factor “relaxation motivation” with respect to the 24 sound contents classified into the six types and the four volumes in the case where the planting 90 is provided inside the space 5, and the value of the factor “concentration” with respect to the 24 sound contents in the case where the planting 90 is provided inside the space 5. Note that, in FIG. 25, similarly to FIGS. 9 and 10, with respect to the sound content of the type “background noise”, the volume of the sound content is described with the actual volume (for example, “35 dB (=40 dB−5 dB)”).

The fourth selection list illustrated in FIG. 24 is created on the basis of the values (values on a horizontal axis) of the factor “relaxation motivation” and the values (values on a vertical axis) of the factor “concentration” with respect to the 24 sound contents classified into the six types and the four volumes illustrated in FIG. 25, and the values (values on a vertical axis) of the factor “preferable space” with respect to the 24 sound contents classified into the six types and the four volumes illustrated in FIG. 21.

In the fourth selection list illustrated in FIG. 24, the value of the factor “concentration” of the sound content of the type “river” and the volume “−5 dB”, in which the value of the factor “preferable space” (FIG. 21) is higher than the median value, and the value of the factor “relaxation motivation” and the value of the factor “concentration” (FIG. 25) are around the median values, is used as a reference value. The fourth selection list illustrated in FIG. 24 illustrates an example in which eight sound contents in which the value of the factor “concentration” is equal to or more than the reference value are arranged in order of magnitude of the value of the factor “concentration” as indicated by bold arrows in FIG. 25.

Note that the number of step numbers included in the fourth step list and the number of sound contents included in the fourth selection list are not limited to eight as illustrated in FIG. 24, and only need to be the same number. In addition, the reference value of the fourth selection list is not limited to the above, and may be, for example, a value of the factor “concentration” of the sound content of the type “background noise” and the volume “0 dB” (actually, 40 (=40−0) dB) which are the same as the base sound indicating the background noise of space 5.

According to the second embodiment, in the case where the planting 90 is provided in the space 5 where the user is present, the sound content having the value of the factor corresponding to the relaxation degree (or the concentration degree) of the user is reproduced in the space 5. Therefore, a sound environment suitable for the relaxation degree (or the concentration degree) of the user is formed in the space 5, and the relaxation degree (or the concentration degree) of the user can be brought close to the target state.

Modifications below can be employed for the present disclosure.

(1) In the first selection list (FIG. 13), the second selection list (FIG. 15), the third selection list (FIG. 22), and the fourth selection list (FIG. 24), the sound content associated with the step number “STEP0” may be changed to the background noise of the space 5 actually collected by the microphone 4. The present configuration can be realized as described below, for example.

When the selection unit 103 selects the sound content associated with the step number “STEP0” as the sound content to be reproduced in steps S14, S15, S24, and S25, the processing is interrupted, and the communication unit 12 is controlled to transmit a control signal indicating an instruction to transmit, to the microphone 4, the audio data to the information processing device 1. In response to this, when the microphone 4 transmits the audio data indicating the audio collected inside the space 5 to the information processing device 1 and the communication unit 12 receives the audio data, the selection unit 103 performs audio analysis on the audio data and extracts audio data (hereafter, background noise data) indicating the background noise of the space 5 included in the audio data. The selection unit 103 reselects the background noise data as the sound content to be reproduced, and the processing proceeds to step S16 or step S26.

According to the present configuration, in the case where the relaxation degree (or the concentration degree) of the user has not reached the target state, the sound content is reproduced which has the higher value of the factor than that of the background noise of the space where the user is present. Therefore, in the present configuration, the relaxation degree (or concentration degree) of the user can be improved as compared with the case where the sound content is not reproduced, and the state can be brought close to the target state.

(2) In step S13 (FIG. 12), the selection unit 103 may further shorten the predetermined time X as a difference between the relaxation degree estimated in step S12 and the target value of the relaxation degree set in step S1 is larger. Similarly, in step S23 (FIG. 12), the selection unit 103 may further shorten the predetermined time X as a difference between the concentration degree estimated in step S22 and the target value of the concentration degree set in step S1 is larger.

According to the present configuration, as the difference between the relaxation degree (or the concentration degree) of the user and the target value is larger, a frequency of gradually improving or suppressing the relaxation degree (or the concentration degree) of the user is increased, and the relaxation degree (or the concentration degree) of the user can be quickly brought close to the target value.

(3) As illustrated in FIG. 16, the sound content of the type “bell cricket” and the volume “−5 dB” has the lower value of the factor “concentration” than that of the sound content of the type “rain” and the volume “0 dB”. However, the arrangement order of the sound content of the type “bell cricket” and the volume “−5 dB” in the second selection list illustrated in FIG. 15 is order after the sound content of the type “rain” and the volume “0 dB”.

As a result, in the above-described first embodiment, in a case where step S24 (FIG. 12) is performed under the sound environment in which the sound content of the type “rain” and the volume “0 dB” is reproduced, or in a case where step S25 (FIG. 12) is performed under the sound environment in which the sound content of the type “sea” and the volume “0 dB” in which the value of the factor “concentration” is remarkably higher than that of the sound content of the type “rain” and the volume “0 dB” is reproduced, it is possible to avoid that a large change in the value of the factor “concentration” excessively affects the concentration degree of the user.

Similarly, also in the fourth selection list (FIG. 24), the arrangement order of the sound contents may be changed so as to reduce the change in the value of the factor “concentration”. Similarly, also in the first selection list (FIG. 13) and the third selection list (FIG. 22), the arrangement order of the sound contents may be changed so as to reduce the change in the value of the factor “relaxation motivation”.

(4) In the processing illustrated in FIG. 12, step S1 may be omitted, and after the start of the processing illustrated in FIG. 12, the selection unit 103 may set the target value of the relaxation degree of the user as in step S1, and then perform the processing in and after step S10. Alternatively, in the processing illustrated in FIG. 12, step S1 may be omitted, and after the start of the processing illustrated in FIG. 12, the selection unit 103 may set the target value of the concentration degree of the user as in step S1, and then perform the processing in and after step S20.

(5) In the processing illustrated in FIG. 12, at least one of step S15 and step S25 may be omitted.

(6) In the processing illustrated in FIG. 12, step S10 may be omitted, and the processing illustrated in FIG. 12 may be ended after step S16. In the processing illustrated in FIG. 12, step S20 may be omitted, and the processing illustrated in FIG. 12 may be end after step S26.

(7) In the processing illustrated in FIG. 12, instead of steps S11 and S12, the acquisition unit 101 may acquire the user state received by the communication unit 12 from an external terminal. The external terminal may be, for example, a computer or a mobile terminal that transmits and receives the subjective evaluation result of the user state by the questionnaire or the like, or may be a wearable terminal worn by the user that acquires the biological information and estimates the user state. Furthermore, the external terminal may be a server that communicates with various terminals.

The present disclosure is useful in the field of sound environment in biophilic design.

1. An information processing method in a computer, comprising:
acquiring a value of a factor with respect to each of a plurality of sound contents;
acquiring a user state that is a state of a user related to the factor;
selecting a sound content having the value of the factor according to the user state from the plurality of sound contents; and
reproducing the selected sound content in a space where the user is present.

2. The information processing method according to claim 1, wherein
the plurality of sound contents include a predetermined sound content, and
in the selection, in a case where the user state has not reached a target state, any one sound content having a higher value of the factor than that of the predetermined sound content is selected.

3. The information processing method according to claim 2, wherein in the selection, in a case where the user state exceeds the target state, any one sound content having a lower value of the factor than that of the predetermined sound content is further selected.

4. The information processing method according to claim 2, wherein
background noise of the space is further acquired, and
in the selection, the background noise in the space is set as the predetermined sound content.

5. The information processing method according to claim 2, wherein
the acquisition, the selection, and the reproduction of the user state are repeated every time predetermined time elapses, and
in the selection, a sound content being reproduced in the space is set as the predetermined sound content.

6. The information processing method according to claim 1, wherein
the plurality of sound contents include a plurality of types of sound contents, and
each of the types of the sound contents includes sound contents of one or more volumes.

7. The information processing method according to claim 6, wherein each of the one or more volumes is represented by a volume of a difference with respect to a volume of background noise in the space.

8. The information processing method according to claim 2, wherein
in the acquisition of the user state, a relaxation degree indicating a degree of relaxation of the user is acquired as the user state,
the target state is a state in which the relaxation degree is a predetermined value, and
the value of the factor is a value indicating a degree of influence of each of the sound contents on the relaxation degree.

9. The information processing method according to claim 2, wherein
in the acquisition of the user state, a concentration degree indicating a degree of concentration of the user is acquired as the user state,
the target state is a state in which the concentration degree is a predetermined value, and
the value of the factor is a value indicating a degree of influence of each of the sound contents on the concentration degree.

10. The information processing method according to claim 5, wherein
in the selection,
a list is acquired in which sound contents each having the value of the factor equal to or more than a reference value among the plurality of sound contents are arranged in order of a magnitude of the value of the factor, and
a sound content having arrangement order in the list before or next to the predetermined sound content is selected.

11. The information processing method according to claim 10, wherein
a value of another factor with respect to the plurality of sound contents is further acquired, and
in the selection, the list is acquired in which the value of the factor of a sound content having a highest value of the other factor among the plurality of sound contents is set as the reference value.

12. The information processing method according to claim 11, wherein the value of the other factor is a value indicating a degree of influence of each of the sound contents on preferability of the space.

13. The information processing method according to claim 1, wherein
an adjustment value of the factor is further acquired, the adjustment value being a value of the factor with respect to each of the plurality of sound contents in a case where a predetermined facility is provided in the space, and
in the selection, in the case where the predetermined facility is provided in the space, a sound content having the adjustment value of the factor according to the user state is selected from the plurality of sound contents.

14. The information processing method according to claim 13, wherein the predetermined facility is planting.

15. The information processing method according to claim 5, wherein
in the selection,
the predetermined time is shortened as a difference between the user state and the target state is larger.

16. An information processing device comprising:
a factor acquisition unit that acquires a value of a factor with respect to each of a plurality of sound contents;
an acquisition unit that acquires a user state that is a state of a user related to the factor;
a selection unit that selects a sound content having a value of the factor according to the user state from the plurality of sound contents; and
a reproduction unit that reproduces the selected sound content in a space where the user is present.

17. A non-transitory computer readable storage medium storing a program of an information processing device, the program causing the information processing device to function as:
a factor acquisition unit that acquires a value of a factor with respect to a plurality of sound contents;
an acquisition unit that acquires a user state that is a state of a user related to the factor;
a selection unit that selects a sound content having a value of the factor according to the user state from the plurality of sound contents; and
a reproduction unit that reproduces the selected sound content in a space where the user is present.

18. The information processing method according to claim 1, wherein
biological information of the user sensed by a sensor is further acquired, and
in the acquisition of the user state, the user state is estimated on a basis of the biological information of the user.
